(19) United States
(12) Patent Application Publication
(10) Pub. No.: US 2025/0044141 A1
(43) Pub. Date: Feb. 6, 2025

(54) MOBILE, LOW PROFILE STORAGE TANK SENSOR MONITORING ANALYTIC MANAGEMENT SYSTEM AND METHODS

(71) Applicant: AlphaHive LLC, Springville, UT (US)

(72) Inventors: Michael A. Jensen, Springville, UT (US); Thomas William Karlinsey, American Fork, UT (US); Daniel Arnaudov Sharp, Saratoga Springs, UT (US)

(21) Appl. No.: 18/796,549

(22) Filed: Aug. 7, 2024

Related U.S. Application Data
(63) Continuation-in-part of application No. 18/643,445, filed on Apr. 23, 2024.
(60) Provisional application No. 63/517,177, filed on Aug. 2, 2023.

(51) Int. Cl. G01F 23/284; G01F 23/80; G08B 21/18

(52) U.S. Cl. CPC G01F 23/284; G01F 23/804; G08B 21/182

(57) ABSTRACT

A monitoring system for a mobile liquid storage tank includes a plurality of independently operable sensor elements each configured to measure a liquid level inside the mobile liquid storage tank and a processor which iteratively receives a liquid level measurement from the sensor elements, determines a single liquid level output measurement that is robust to measurement variation by one or more of the plurality of independently operable sensor elements, and determines at least one liquid level usage analytic. A display is also provided which visually presents the at least one liquid level usage analytic.

### CROSS REFERENCE TO RELATED APPLICATIONS

This application is a continuation-in-part application of U.S. application Ser. No. 18/643,445 filed Apr. 23, 2024, which claims the benefit of U.S. Provisional Application Ser. No. 63/517,177 filed Aug. 2, 2023, the entire disclosure of which is hereby incorporated by reference in its entirety.

### BACKGROUND OF THE INVENTION

The field of the invention relates generally to radar sensor liquid level detection systems, and more specifically to intelligent analytic systems and methods operative with respect to liquid level detection data from the radar sensor liquid level detection systems to realize a real-time proactive management of liquid utilization in mobile, low-profile liquid storage tanks.

Sensor systems are well known and in widespread use for sensing liquid levels in large capacity industrial storage tanks in industrial settings and industrial processes. More specifically, radar sensor systems exist which beneficially monitor liquid levels in industrial applications, particularly with respect to preventing an undesirable overfilling of liquid storage tanks. While such radar sensor systems may work rather well in such industrial liquid monitoring applications, they are disadvantaged in some aspects for monitoring liquid level in storage tanks that are outside of the industrial realm.

For example, lower capacity storage tanks in non-industrial settings, and particularly mobile storage tanks that are movable to different locations, present additional challenges that can undesirably impact radar sensor measurements of liquid level, rendering existing radar sensor systems unreliable and therefore impractical for meaningful use in certain applications. Particularly for mobile, low-profile liquid storage tanks which are widely utilized in certain types of vehicles, conventional radar sensor systems are prone to unacceptable inaccuracies in sensing liquid levels. Improved liquid level detection systems and methods are therefore desired.

Additionally, and also in certain types of vehicles, liquid tank storage levels can be critical to the use and enjoyment of the vehicle at locations wherein needed liquids may not be easily emptied or replenished. Because of the inaccuracies of conventional liquid level sensors, vehicle owners and occupants tend to lack reliable information regarding liquid level storage detection, making it difficult to proactively manage stored liquid level issues. Reliable decision-making criteria is therefore elusive regarding when to fill or empty storage tanks on the vehicle in a manner that avoids undesirable and unpleasant vehicle use disruptions from unanticipated liquid level storage issues, avoids unnecessary tank filling and tank emptying events which facilitates a more efficient use of the vehicle, and better facilitates planned liquid level storage maintenance while reducing stress and anxiety of vehicle owners and occupants. Improved liquid level analytic systems and methods are therefore desired to determine and communicate accurate, real-time liquid level data and information in a user friendly form including intuitive graphical screen displays and menu-driven information access, in combination with liquid level conservation measures to avoid a loss of use and enjoyment of the vehicle until liquid levels in storage tanks can be replenished or emptied as needed.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective view of an exemplary mobile, liquid storage tank.

FIG. 2 is a cross-sectional view of the mobile, liquid storage tank shown in FIG. 1 illustrating issues posed in the accurate determination of a sensed liquid level with a radar sensor.

FIG. 3 is a cross-sectional view similar to that of FIG. 2 including an exemplary radar sensor system in accordance with an embodiment of the present invention.

FIG. 4 illustrates a monostatic radar sensor implementation of the radar sensor system shown in FIG. 3 in accordance with an exemplary embodiment of the present invention.

FIG. 5 illustrates a bistatic radar sensor implementation of the radar sensor system shown in FIG. 3 in accordance with an exemplary embodiment of the present invention.

FIG. 6 illustrates a first multiple-input multiple-output (MIMO) radar sensor implementation of the radar sensor system shown in FIG. 3 in accordance with an exemplary embodiment of the present invention.

FIG. 7 illustrates a second multiple-input multiple-output (MIMO) radar sensor implementation of the radar sensor system shown in FIG. 3 in accordance with an exemplary embodiment of the present invention.

FIG. 8 illustrates an exemplary operation of a first portion of the MIMO radar sensor implementation shown in FIG. 7.

FIG. 9 illustrates an exemplary operation of a second portion of the MIMO radar sensor implementation shown in FIG. 7.

FIG. 10 illustrates an exemplary radar power plot for a first transmitter/receiver pair shown in FIG. 8.

FIG. 11 illustrates an exemplary radar power plot for a second transmitter/receiver pair shown in FIG. 8.

FIG. 12 illustrates an exemplary radar power plot for a third transmitter/receiver pair shown in FIG. 8.

FIG. 13 illustrates an exemplary radar power plot for a first transmitter/receiver pair shown in FIG. 9.

FIG. 14 illustrates an exemplary radar power plot for a second transmitter/receiver pair shown in FIG. 9.

FIG. 15 illustrates an exemplary radar power plot for a third transmitter/receiver pair shown in FIG. 9.

FIG. 16 illustrates exemplary processes of determining liquid level in a storage tank utilizing the radar sensor systems and implementations of FIGS. 3-9 and operating upon multiple transmitter/receiver pair power plots such as those illustrated in FIGS. 10-15.

FIG. 17 schematically illustrates a liquid level detection radar sensor system in accordance with an exemplary embodiment of the present invention.

FIG. 18 illustrates exemplary algorithmic processes 450 for analytical monitoring and management of liquid usage based on operation of the sensor system shown in FIG. 17.

FIG. 19 illustrates a first exemplary user interface graphical screen display including fill/empty storage tank analytics generated by the processes illustrated in FIG. 18 and implemented in the system shown in FIG. 17.

FIG. 20 illustrates a second exemplary user interface graphical screen display including daily and hourly liquid usage summary analytics generated by the processes illustrated in FIG. 18 and implemented in the system shown in FIG. 17.

FIG. 21 illustrates a third exemplary user interface graphical screen display including elapsed liquid usage analytics generated by the processes illustrated in FIG. 18 and implemented in the system shown in FIG. 17.

FIG. 22 illustrates a fourth exemplary user interface graphical screen display including periodic liquid usage analytics generated by the processes illustrated in FIG. 18 and implemented in the system shown in FIG. 17.

FIG. 23 illustrates a fifth exemplary user interface graphical screen display including predictive, elapsed, percent full or empty, and liquid usage notification analytics generated by the processes illustrated in FIG. 18 and implemented in the system shown in FIG. 17.

FIG. 24 illustrates a sixth exemplary user interface graphical screen display including peak liquid usage analytics generated by the processes illustrated in FIG. 18 and implemented in the system shown in FIG. 17.

FIG. 25 illustrates a seventh exemplary user interface graphical screen display including a predictive analytic generated by the processes illustrated in FIG. 18 and implemented in the system shown in FIG. 17.

FIG. 26 illustrates an eighth exemplary user interface graphical screen display including a critical level warning analytic generated by the processes illustrated in FIG. 18 and implemented in the system shown in FIG. 17.

FIG. 27 illustrates a ninth exemplary user interface graphical screen display including a critical level warning analytic with responsive action options generated by the processes illustrated in FIG. 18 and implemented in the system shown in FIG. 17.

FIG. 28 illustrates a tenth exemplary user interface graphical screen display including an audio alert notification generated by the processes illustrated in FIG. 18 and implemented in the system shown in FIG. 17.

FIG. 29 illustrates an eleventh exemplary user interface graphical screen display including a leak detection notification generated by the processes illustrated in FIG. 18 and implemented in the system shown in FIG. 17.

FIG. 30 is a block diagram of a portion of a liquid usage analytical monitoring and management system executing the exemplary processes of FIG. 18 including the screen displays shown in FIGS. 19-29.

FIG. 31 illustrates another cross-sectional view of the mobile, liquid storage tank shown in FIG. 2 with further exemplary liquid level sensors and liquid usage sensors and controls.

### DETAILED DESCRIPTION

In order to understand the inventive concepts described herein to their fullest extent, some discussion of the state of the art and of certain problems and disadvantages that exist in the art is set forth below, followed by exemplary embodiments of improved radar sensor systems and methods that advantageously overcome the limitations of existing liquid level detection systems.

Apart from sophisticated industrial monitoring systems for large high-capacity industrial storage tanks, relatively unsophisticated sensor systems exist to measure liquid levels in relatively small, low-capacity liquid storage tanks outside of industrial environments and for non-industrial uses. Unlike high-capacity industrial liquid storage tanks that are stationary by design, such low-capacity tanks are relatively small and lightweight and are therefore mobile in that they are easily transported from location to location for desired use, and in some cases may supply or collect liquid while in transit.

Relatively low cost probe sensors are known that extend inside such mobile storage tanks to provide a rudimentary form of liquid level detection inside the tank. The probe sensors may be plug-type sensors that are attached to the tank from the outside but extend into the tank for liquid level detection at designated positions on the tank interior. For example, four probe sensors may be utilized in combination at correspondingly different elevations to detect, for example, a full tank, a ⅔ full tank, and a ⅓ full tank via three of the respective probe sensors provided, with the fourth probe sensor at the bottom of the tank providing electrical conductivity for the operation of the other three probe sensors. Such large gradation in liquid level detection presents significant undesirable ambiguity in the amount of liquid actually in the storage tank and therefore frustrates proactive management of the liquid in the tank that may otherwise be desired in certain end use applications.

For example, the actual liquid level in a mobile tank may become a critical concern for an owner of a recreational vehicle (RV) or another similarly situated vehicle because the amount of available liquid may affect the practical use, enjoyment and operation of the vehicle. For instance, when the vehicle owner or operator may not easily or quickly be able to replenish a water supply tank at the present location of the vehicle or when a grey or black water tank may unexpectedly fill without a corresponding ability to empty the tank at the current location of the vehicle, the vehicle may be rendered partly inoperable in important aspects to the end user. Because of the large gradation in liquid level sensing when probe sensors are utilized, however, the actual water level in the tank may be considerably different from that indicated by the probe sensors. A more accurate and reliable liquid sensor system is therefore desired which affords a more meaningful opportunity for the vehicle owner, vehicle operator or affected occupants of the vehicle to take more proactive steps to manage water use and when needed, to conserve water until the storage tank can be replenished or refilled or until a grey or black water tank can be emptied.

Apart from ambiguity issues regarding specifically how full a tank may be at any time, reliability of known probe sensors can be particularly affected by sediment or solids inside the storage tank being monitored. Specifically for grey water or black water tanks that collect non-potable water, sediment inside the tanks may affect the operation of one or more of the probes to the point where they may fail to detect the corresponding liquid level in the tank. Once the grey or black water tanks are full, key functionality of the RV may be compromised, including but not limited to any further use of fresh water in the vehicle that may otherwise be available. Surprises in liquid level for grey or black water tanks are therefore particularly unwelcome and more reliable liquid level sensors are needed.

The issues posed by probe sensors above are partly solved by existing alternative capacitive sensors that may be attached to an exterior side wall of a mobile storage tank. Capacitive sensors of this type may include two vertical strips of metal with small horizontal spacing between them. The capacitance between the strips varies depending on the level of the liquid in the tank. Some capacitive sensors consist of a single large vertical strip with additional smaller strips arranged as an array in a predetermined vertical spacing from one another. The array of smaller strips is positioned to the side (horizontally) of the larger vertical strip. Each smaller strip in the array detects the water level through the tank side wall at the corresponding elevation of each strip on the side wall. Because such capacitive sensors are not inside the tank they are not as prone to reliability issues because of conditions inside the tank, and more capacitive strips can easily be provided to realize a finer gradation in measured liquid levels such as in 3-5% increments instead of 33% increments via sensor probe systems. Less ambiguity in actual water level via finer gradation of water level detection is therefore possible, although the capacitive sensors in the array can sometimes be unreliable and can introduce additional expense and complication due to the greater number of sensors needed to operate this type of system.

For instance, to sense the full range of zero to 100% liquid level in the tank in 5% increments, 20 sensors would be needed on the tank side wall. A relatively complex communication and control setup would also be needed to independently operate the 20 sensors, process the sensor outputs and provide the desired water level output over time for the benefit of the end user or an automated control system. Such expense and complication in the communication and control setup would further be incurred on a per-tank basis, so a monitoring of three liquid storage tanks with sensors arranged to measure liquid level in 5% increments each would require 60 sensors (20 for each of the three tanks) that would individually need to communicate with a centralized processing unit. System installation and setup, as well as diagnosing and troubleshooting a system having such a large number of sensors to achieve and maintain its full operation can be challenging and at least for certain systems and certain end users would preferably be avoided. Simpler sensor systems are therefore desired.

Float sensors are sometimes used in small mobile tanks such as vehicle fuel tanks. However, float sensors are not reliable in black and grey water conditions.

Ultrasonic or sonar sensors have also been used for level sensing in mobile, low-profile storage tanks but with limited success. The physics of acoustic wave propagation through the liquid being measured and the bandwidth available for ultrasonic sensors are limiting factors in the performance of these types of sensors. Radar sensors offer promise to provide precise, accurate, real-time and non-gradated liquid level determination for a mobile storage tank. As noted above, radar sensor liquid level detection systems exist that work well to monitor liquid levels in large capacity, stationary storage tanks in industrial settings, but they are disadvantaged for use in smaller capacity, mobile tanks in non-industrial settings. For example, smaller and lighter storage tanks that may be moved from location to location, including but not limited to storage tanks that are components of vehicle systems, require smaller and more economical sensor components and controls relative to industrial counterpart systems.

Radar sensors for mobile, low-profile storage tanks do currently exist in the marketplace but with limited or poor performance because of the challenges described below.

For a storage tank that is relatively small and shallow, sometimes referred to as a “low-profile” storage tank which is specifically contrasted with relatively large and tall/deep tanks used in industrial applications, additional challenges exist to realizing accurate and useful liquid level sensing via radar sensors that are located outside of the storage tank and therefore measure the liquid level through a top wall of the tank. Unlike their larger industrial counterparts, smaller, low-profile storage tanks may have, and often do have, a non-uniform wall thickness, resulting in radar sensor readings of liquid level that are less accurate than desired. In a shallower storage tank, inaccurate radar readings of liquid levels attributable to variations in the top wall of the tank can be considerably more consequential from a controller and oversight perspective than in deeper tanks.

As a simple example, consider a generally rectangular storage tank having a shallower depth (measured in a vertical direction or the height direction) of 12 inches as opposed to a much taller storage tank having a depth of 120 inches. If a variation in the top wall surface of each of these tanks causes errors in measurements that are within 2 inches of the top of the tank, then the larger tank will exhibit errors when it is more than 98% full but the smaller tank will exhibit errors when it is more than 83.3% full. This is not acceptable for storage tanks in a RV, food truck or recreational boat.

The unwelcome result from the examples above is that the actual water level in the tank in an RV, food truck or recreational boat using existing sensor technology may not be reliably determined. Detected levels by existing sensor technologies may be more or less, and sometimes may be considerably more or less, than the actual liquid level at any given point in time. Particular problems may be presented for grey and black water tanks when the actual liquid level is greater than what existing sensors indicate. In addition to water tanks, parallels exist for monitoring of other types of liquids such as fuel (e.g., gasoline, diesel fuel, propane) that may likewise be utilized in vehicles such as RV's, food trucks and recreational boats.

Still another problem is presented by shallower, low-profile storage tanks as opposed to larger ones, namely that the liquid in the storage tank may condense and collect or build up on the inner surface of the top wall in the form of droplets. When a tank is moved or jostled, splashing may also cause droplets to form on the inner surface of the top wall. If a droplet happens to coincide with the location of a radar sensor transmitter or receiver, the presence of the droplet can affect the radar return and contribute to an erroneous discrepancy in the sensed liquid level versus the actual liquid level in the storage tanks. Similar to the example above relating to wall thickness of the storage tank, such error would be more pronounced in the shallower, low-profile tank than in the deeper tank. Considering that a droplet and a wall imperfection may occur at the same location to affect a radar transmitter or receiver, the variation becomes unpredictable. For example, if variation was caused by the wall thickness alone, the effect could potentially be removed by calibration, but with the addition of variation caused by water droplets that are transitory in nature, calibration is ineffective.

Still further, and depending on the liquid being monitored, a buildup of solids may occur inside the tank that can affect a reading at the location of a radar transmitter or receiver and contribute to an inaccurate liquid level measurement by the transmitter/receiver pair. As used herein, a transmitter/receiver pair is a combination of a transmitter and a receiver. In reference to transmitters and receivers the word “pair” and the word “combination” are both used, with “combination” denoting the possibility of more than one transmitter or more than one receiver as set forth in exemplary embodiments described further below. Solid buildup may occur separately or may occur in combination with tank wall variations and liquid buildup to produce transitory errors that cannot be removed through calibration. For example, non-potable water storage tanks may include solid contaminants which may produce a degree of solid/liquid buildup in at least some conditions.

Given the issues above, liquid level readings may be highly sensitive to the particular location where a radar transmitter and receiver is installed relative to the mobile storage tank being monitored, meaning that the liquid level readings with the transmitter and receiver may be more accurate or less accurate depending on their particular location relative to the tank. Since the locations of solid/liquid buildup will also change over time, the liquid level readings may be more or less accurate depending on when the readings are made. The accuracy of any given liquid level reading will depend on any variance (or not) in the top wall thickness and on the degree of liquid or solid buildup inside the tank at the specific location where the respective transmitter and receiver are installed at the time that the liquid level reading is made. Of course, the installer cannot predict or determine at the point of installation exterior to the storage tank where such wall thickness variation may exist, nor can he determine when or where inside the tank solid/liquid buildup may materialize, so the inevitable result is that any single sensor mounting location will fall short of meeting the needs of the marketplace for accurate liquid level sensing in low-profile mobile storage tanks for vehicle use.

The accuracy of a liquid level measurement is affected by the thickness of the upper wall and the build-up of solids and liquids on the inner surface of the upper wall for two reasons. Firstly, the radar returns through and/or from the upper wall or the build-up can interfere with measurements of the liquid level, with the effect more pronounced when the liquid surface is close to the upper wall or the build-up as described in more detail below. Secondly, the power level of the returns from the surface of the liquid will be reduced if reflections from and absorption by the upper wall or the buildup reduce the received radar signal level.

Turning now to the Figures, exemplary embodiments of mobile storage tanks and liquid level detection radar sensor systems and methods of the present invention therefore will now be described that beneficially overcome the limitations described above with respect to the state of the art. Method aspects will be in part apparent and in part explicitly discussed in the following description.

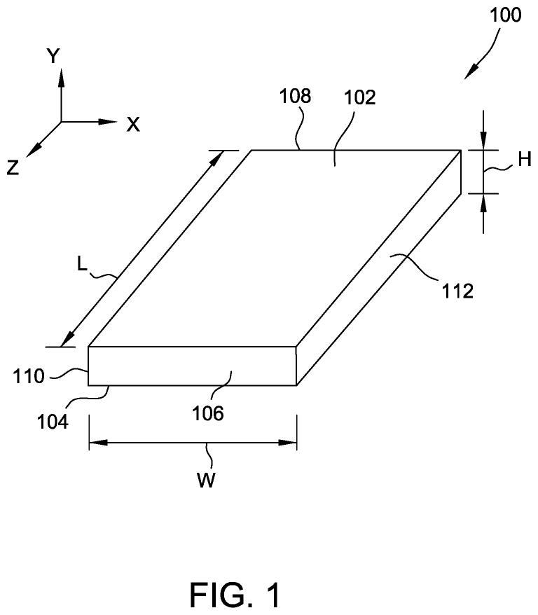

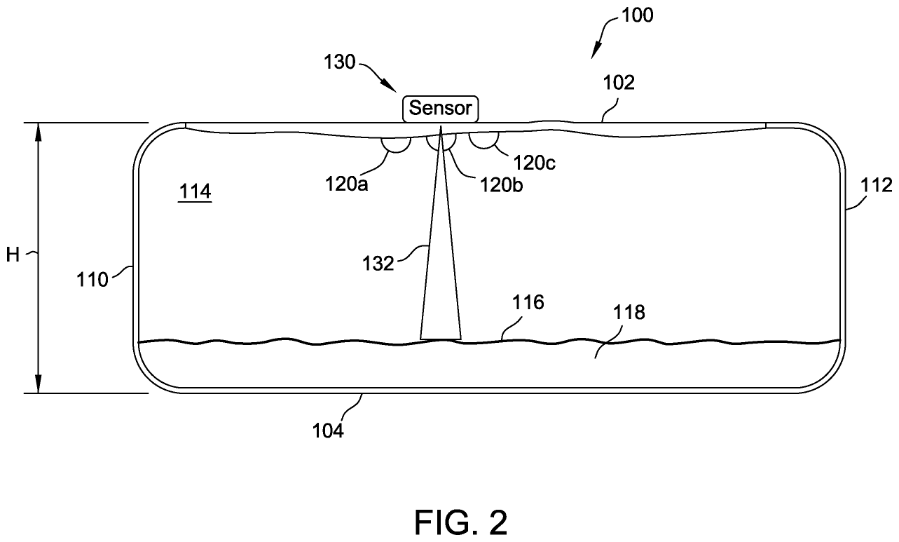

FIGS. 1 and 2 are a perspective view and cross-sectional view, respectively, of an exemplary mobile storage tank 100 upon which the radar sensor system and methods of the present invention described further below are beneficially operable with vastly improved accuracy than existing systems. The storage tank 100 is formed in an elongated rectangular shape in the embodiment shown including a top wall 102, a bottom wall 104 opposing the top wall, lateral end walls 106 and 108 interconnecting opposing edges of the respective top and bottom walls 102 and 104, and longitudinal side walls 110 and 112 interconnecting the respective edges of the walls 102 through 108. The walls 102 through 112 enclose an interior cavity 114 (FIG. 2) having a capacity to store a predetermined amount of liquid therein.

In contemplated embodiments, the liquid capacity of the tank 100 is about 150 gallons or less. In further contemplated embodiments, the capacity of the tank is about 15 gallons to about 150 gallons. In this aspect the capacity of the tank 100 is considerably less than the capacity of a typical industrial liquid storage tank. The reduced capacity of the tank 100 reduces the weight of the storage tank 100 when filled with liquid and reduces the size of the tank, advantageously contributing to the mobility of the tank to be easily transported between different locations for use at different sites.

To further contribute to the mobility of the tank 100, in contemplated embodiments the tank 100 is fabricated from a relatively lightweight non-metal material such as plastic, fiberglass or another suitable material as opposed to heavier metallic materials commonly used to fabricate industrial storage tanks. Non-metallic material construction for the tank 100 is also compatible for use with radar sensors which may easily transmit and receive through the walls of the tank 100 without having to create openings in the tank side walls. It is understood, however, that in some embodiments the tank 100 could be metallic if such openings were included to facilitate an operation of radar sensors located exterior to the tank 100.

The storage tank 100 includes an inlet (not shown) for filling of the interior of the tank 100 with a liquid and an outlet (also not shown) for discharging liquid from the storage tank 100. In some contemplated embodiments, the liquid in the tank 100 is water. Depending on the type of water being stored, the storage tank 100 may sometimes be referred to as a freshwater tank, a grey water tank, or a black water tank in the context of an RV, food truck, living quarters of semi-trucks, or recreational marine vehicles as opposed to large commercial marine vehicles including shipping vessels and industrial vessels that have much higher capacity storage tanks that do not present the same concerns. In other contemplated embodiments, the liquid may be fuel such as gasoline, diesel fuel, or propane in non-limiting examples. It is understood that the sensor systems and methods of the invention are not necessarily limited to any particular type of liquid stored in the tank 100. It is also understood that the sensor systems and methods of the invention are not necessarily limited to vehicle storage tanks.

The storage tank 100 in the example shown has a width dimension W measured along an x axis of a Cartesian Coordinate system, a height dimension H measured along a y axis that is perpendicular to the x axis in the Cartesian Coordinate system, and a length dimension L measured along a z axis that is perpendicular to the x axis and the y axis in the Cartesian Coordinate system. In the example shown, the height dimension H is much smaller than the width dimension W which is in turn smaller than the length dimension L. The disproportionately small height dimension H relative to the width and length dimensions L and W is sometimes referred to as a shallow or low-profile tank configuration. As a result, liquid inside the shallow tank 100 has a reduced depth in the vertical dimension H relative to other tank configurations that do not have a low-profile configuration. While a rectangular-shaped low-profile tank is shown, the tank 100 need not necessarily be rectangular and other low-profile tank shapes such as round, disc-shaped tanks may be likewise adopted as a non-limiting example.

In contemplated examples, the storage tank 100 has a low-profile configuration for use in an RV, a food truck, a recreational boat or a semi-truck with living quarters as non-limiting examples. As such, in contemplated embodiments, the low-profile height dimension of the tank 100 may be between about 2 inches (5.08 cm) and about 30 inches (76.2 cm). In more specific embodiments, the low-profile height dimension of the tank 100 may be between about 4 inches (10.16 cm) and 9 inches (22.86 cm). It should be recognized, however, that such low-profile height dimensions are non-limiting examples. The operation of the inventive sensor systems and methods described below does not necessarily depend on a specific low-profile height dimension of the tank 100, and in some cases the inventive sensor systems and methods could be used satisfactorily on storage tanks that are not low-profile tanks at all.

Often when liquid storage tanks are installed for mobile applications such as RVs, very little space remains between the top of the tank and the structure above it. Thus, a low-profile sensor is also needed for the low-profile storage tank 100. Sensor size is typically not a consideration for tanks that do not have similar space constraints or for large-capacity industrial storage tanks. The sensor systems and methods described below are particularly well suited for use as low-profile sensors in applications where other types of larger sensors cannot be used.

Whether or not having a low-profile configuration, the tank 100 in contemplated examples could be used in a non-vehicle application such as a porta-potty as another non-limiting example. The benefits of the invention are not necessarily limited to portable tanks either. For example, the tank 100 could be a septic tank which would benefit from the inventive sensor system apart from any mobility or portability thereof. The exemplary liquid storage tanks described herein are therefore described for the sake of illustration rather than limitation. The benefits of the sensors, systems and method processes described below may generally accrue to various different types of tanks and various different types of liquids wherein liquid level monitoring is desirable.

As shown in cross-sectional view in FIG. 2, the low-profile storage tank 100 is furnished with a low-profile sensor 130 fixedly mounted on the exterior of the top wall 102. The sensor 130 may be a radar sensor which transmits a radar signal 132 from above the tank 100 to and through the top wall 102. The transmitted radar signal is reflected off the surface 116 of the liquid 118 inside the tank 100 and back through the top wall 102 without requiring an opening in the top wall to transmit or receive radar signals. The returned radar signal data may be analyzed by a processor internal to or separately provided from the sensor 130 to determine the vertical distance between the liquid surface 116 and the sensor 130. Once determined, this distance can easily be converted to indicate the amount of liquid (i.e., the liquid level) in the tank on a percentage basis of a full or empty tank as desired. A corresponding output to a human user or to another control device in an automated system can therefore be provided.

Ideally, and in theory, the radar sensor 130 may precisely determine the exact liquid level in the tank 100 without relying upon any other sensing element. As FIG. 2 shows, however, there are at least two non-ideal complicating factors presented by the storage tank 100 that affect the accuracy of the liquid level reading obtained by the radar sensor 130.

First, as shown in FIG. 2 the tank 100 has a non-uniform wall thickness in the top wall 102 that affects the radar signal transmission in a manner that tends to reduce the accuracy of the measured liquid level. In the example shown, the thickness of the top wall through which the radar signal 132 from the sensor 130 travels is greater (or smaller) than the top wall thickness at other locations along the top wall 102. Radar signal transmission through different wall thicknesses will produce varying radar signal returns which can distort the measurements. For example, the speed at which the radar signal 132 propagates in the material of the top wall 102 differs from the speed at which the radar signal 132 propagates in the air below the top wall. This difference in propagation speed will impact the detected vertical distance between the surface 116 of liquid 118 and sensor 130. Also, reflection of radar signal 132 from the interface between the top wall 102 and the air below may interfere with the reflection from the surface 116 of liquid 118. The ability to separate the reflection off the top wall 102 from that off the surface 116 becomes more difficult when the location of the surface 116 is close to the top wall, which occurs when the liquid level is near the top of the tank. These and possibly other phenomena introduce error in the measured result, or a discrepancy between the detected liquid level and the actual liquid level, which may be more pronounced when the liquid level is near the top of the tank.

As a practical matter, a deviation in thickness of the top wall 102 would not be evident in the installation of the sensor 130, and depending on whether the wall thickness is thinner or thicker, the inaccuracy or error in the sensed result could skew positively or negatively from the actual liquid level in the storage tank 100, especially when the liquid level is near the top of the tank. That is, the sensed liquid level could be under or over the actual liquid level in an unexpected and non-intuitive manner to the interested end user of the liquid in the storage tank 100. Given that some variance may exist between different tanks 100 in this aspect, considerably different performance variations of the sensor 130 may be observed in use on otherwise similar storage tanks 100 with the sensor 130 installed in the same relative position on the storage tanks 100. Such performance variation of the sensor may perhaps invoke understandable but false impressions by end users that the sensor 130 is not working properly. Methods to calibrate the sensor 130 or to process the sensor output in a manner which would compensate for variance in tank construction are not currently known in the art particularly with the compounding effects of liquid and solid buildup.

Second, and as also illustrated in FIG. 2, liquid buildup in the form of droplets 120a, 120b, and 120c are seen clinging to the inner surface of the top wall 102 of the tank 100. Such droplets may form in a generally unpredictable manner in use of the storage tank 100. One of them, namely the droplet 120b, is located in a position where the transmitted and reflected radar signal will have to pass through the droplet 120b. Again, the passage of transmitted or reflected radar signals through the droplet will produce some variation in the returned signal relative to transmitted or reflected radar signals that do not pass through a droplet. Additionally, radar reflections can be present from the top and bottom surfaces of the droplet 120b, further deteriorating the accuracy of the radar measurement of the liquid level. Since the presence of droplets may be transient, it is unclear how to calibrate the sensor 130 or to process the sensor output in a manner which would compensate for their presence, since they may be present at times and not present at other times. Further, in some situations droplets may be present but are nonetheless unproblematic as they are located in areas that simply do not affect the radar signal transmission.

Solids may also accumulate and build up on the inner surface of the top wall of the tank depending on the type of liquid being monitored inside the tank 100. As such, instead of liquid droplets, the elements 120a, 120b, and 120c could represent solids which could produce further variance in the sensor reflected radar signal output via transmitted and received radar signals passing through or reflections from the solid material clinging to the top wall 102 inside the tank 100. Such solid buildup would likewise occur in a manner that could not practically be predicted and may be transient in nature such that it may intermittently affect the measured liquid level by the sensor 130. On occasion, both solid and liquid buildup may combine such that transmitted and received radar signals must pass through and may be reflected from each of solid and liquid buildup producing variance in the measured sensor readings of the liquid level. Once again, practical methods to calibrate the sensor 130 or to process the sensor output in a manner which would compensate for the obstruction of radar signal transmissions through solid buildup inside the storage tank 100 are unknown particularly because of the transitory nature of solid buildup and the potential for water buildup that is also very transitory.

In the example of FIG. 2, the sensor signal transmission 132 at the location shown is affected by wall thickness deviation and the presence of solid or liquid buildup represented by 120b. As such, an accumulation of variance in the returned radar signal and the resultant measured liquid level output would occur, and an associated accumulation of error or discrepancy between the actual liquid level and the detected liquid level would be present. Importantly, and as discussed above, the shallower the tank 100 is (i.e., as the low-profile height dimension H becomes smaller) the more pronounced the errors become because the error prone region near the upper wall of the tank would occupy a larger percentage of the total height. The magnitude of the errors may generally be unpredictable from tank to tank and may vary in different operating conditions, generally to the detriment of other systems and persons who depend on the sensed result.

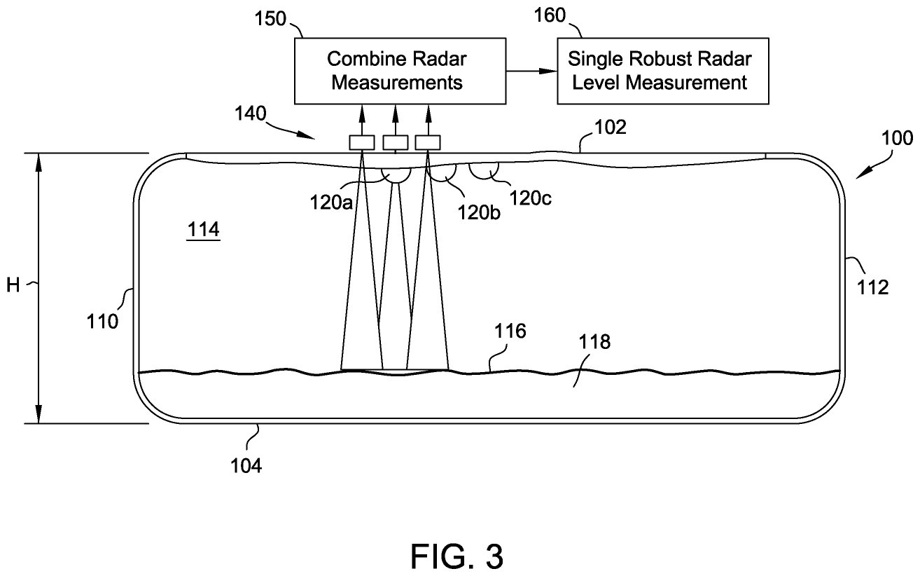

FIG. 3 is an exemplary cross-sectional view similar to that of FIG. 2 but showing an exemplary radar sensor arrangement 140 in accordance with an embodiment of the present invention. Unlike FIG. 2, the tank 100 is now furnished with three discrete radar sensors each independently transmitting radar signals from a transmitter through the top wall 102 of the tank 100 and collecting return signals with a receiver back through the top wall 102. The return signals from each of the three sensors are processed to determine respective liquid levels based on the data from each sensor at each respective location. Output data sets from each of the three transmitter/receiver pairs within the three sensors are, in turn, provided to a processor-based device 150 which combines their outputs to produce a single robust radar level measurement 160 in a manner that reduces errors and magnitude of errors when present due to localized effects in the radar measurements attributable to the construction of the tank 100 and operating conditions inside the tank 100 (e.g., solid and liquid buildup) as discussed above. The processor-based device 150 accordingly provides a single, robust liquid level output measurement 160 that may be more reliably acted upon by control systems and persons to take appropriate actions in view of the liquid level in the tank 100.

In the example of FIG. 3, the three radar sensors from left to right respectively operate with respect to a first signal transmission path that passes cleanly through the top wall 102, a second signal path that passes through the top wall and the thickest portion of the solid/liquid buildup 120a, and a third signal path that passes through the top wall and tangentially through the water droplet 120b. The result will be three different liquid level values detected by each of the three sensors which experience different effects particular to the specific locations from which they operate. Because the three different radar sensors at the three different locations will have different returns from near targets (e.g., the tank wall, clinging water, or clinging solids) the measurements from the three radar sensors can be combined into a single more accurate measurement that is robust to measurement variation caused by the near targets. Mitigation of errors in the individual operation of each sensor is possible with intelligent processing of the sensor outputs as further explained below. While three radar sensors are shown in FIG. 3, similar advantageous effects could be realized with as few as two sensors with two transmitter/receiver pairs or more than three sensors with more than three transmitter/receiver pairs in further and/or alternative embodiments.

Those who are skilled in the art will understand that in standard usage, a transmitter may refer to the radar circuitry that drives an antenna, the antenna itself, or the combination of the circuitry and the antenna. For the purposes of this specification and claims, language that refers to the location or position of the transmitter is intended to describe the location of the transmit antenna that is connected to the radar transmit circuitry. Besides the well understood considerations of transmit loss that may occur between the antenna and the circuitry, the location of the circuitry itself is not important to the functionality of the sensors, systems or methods described herein.

Similarly, those who are skilled in the art will understand that in standard usage, a receiver may refer to the radar circuitry that receives the signal from an antenna, the antenna itself, or the combination of the circuitry and the antenna. For the purposes of this specification and claims, language that refers to the location or position of the receiver is intended to describe the location of the receive antenna that is connected to the radar receive circuitry. Besides the well understood considerations of transmit loss that may occur between the antenna and the circuitry, the location of the circuitry itself is not important to the functionality of the sensors, systems or methods described herein.

Additionally, language herein that refers to the location or position of a transmitter/receiver pair is meant to describe the location or position of the antennas corresponding to the associated transmit circuitry and receive circuitry.

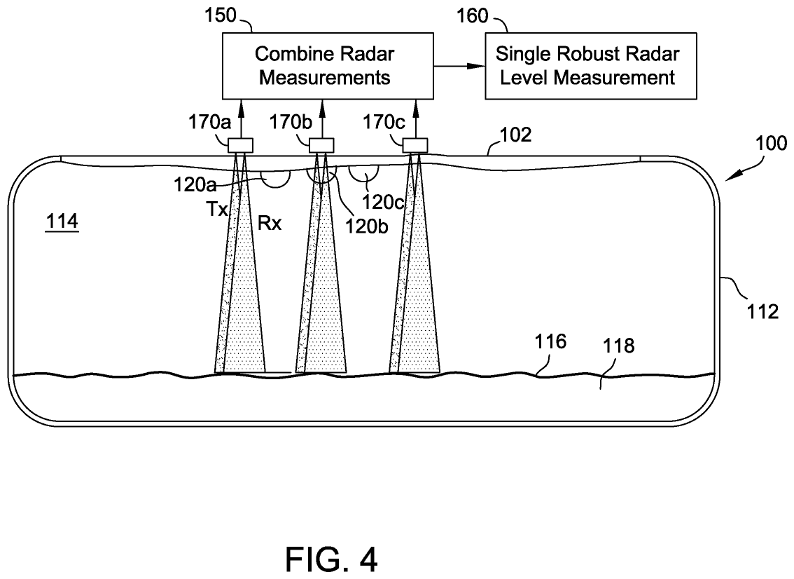

FIG. 4 illustrates a first exemplary radar sensor implementation of the radar sensor system shown in FIG. 3. As shown in FIG. 4, the tank 100 is furnished with three independently operable monostatic radar transmitter/receiver pairs 170a, 170b, and 170c fixedly mounted in spaced-apart relation to one another on the exterior of the top wall 102 of the tank. Monostatic radar circuitry can be designed such that the transmit and receive antennas are in fact the same antenna. In these designs the location of the antenna constitutes the location of the transmitter/receiver pair. In other designs, the transmit and receive antennas are separate antennas, but they are located sufficiently near each other that the design is considered a monostatic radar design. Each radar transmitter/receiver pair 170a, 170b, 170c respectively includes a transmitter Tx and a receiver Rx that are collocated to transmit and receive radar signals toward the surface 116 of the liquid 118 and back. Because of the different locations of the transmitter/receiver pairs 170a, 170b, and 170c different returns from near targets (e.g., the tank wall, clinging water, or clinging solids) are presented. Adoption of three transmitter/receiver pairs 170a, 170b, and 170c at three different locations reduces localized effects by each transmitter/receiver pair that are not likely to be duplicated at each location, such that localized radar signal variance at any one of the locations sensed will not influence the result in the same way relative to a single transmitter/receiver pair operation (FIG. 2).

Adoption of three spaced-apart transmitter/receiver pairs to take three independent liquid level readings at three different locations provides a set of radar readings with an increased possibility of determining an accurate measurement of liquid level. In the example shown in FIG. 4, each of the three transmitter/receiver pairs 170a, 170b, and 170c transmits and receives through respectively different wall thickness at each location, and only one of the three transmitter/receiver pairs, namely the transmitter/receiver pair 170b, transmits and receives through solid/liquid buildup 120b. The solid/liquid buildup 120a, 120b, and 120c does not impact the operation of the radar transmitter/receiver pairs 170a or 170c, such that the operation of the radar transmitter/receiver pairs 170a and 170c is likely to be more accurate and reliable than the operation of the radar transmitter/receiver pair 170b.

In order to mitigate errors represented in the output from each individual transmitter/receiver pair, the processor-based device 150 may combine the outputs of the transmitter/receiver pairs into a single output 160 using algorithms that apply one or more of the following non-limiting operations in contemplated examples: (1) Averaging measurements from all transmitter/receiver pairs; (2) Averaging measurements from all transmitter/receiver pairs that have near-range returns (meaning returns from surfaces very near the sensor) below a specified power threshold; (3) Averaging measurements from all transmitter/receiver pairs that produce liquid level measurements in an expected range; (4) Selecting only the measurement from the transmitter/receiver pair with the lowest near-range return; or (5) Selecting only the liquid level measurement that is closest to an expected measurement.

The operation that averages measurements from all three transmitter/receiver pairs operates in the example of FIG. 4 to mitigate individual error, if present, from one or more of the transmitter/receiver pairs. In the example of FIG. 4, the measurements from transmitter/receiver pairs 170a and 170c are presumably more accurate than the measurement from transmitter/receiver pair 170b because of the buildup 120b that impacts the transmitter/receiver pair 170b but not the transmitter/receiver pairs 170a and 170c. Averaging detected liquid levels of the three transmitter/receiver pairs will reduce the impact of the buildup 120b in the end output 160. For example, if the transmitter/receiver pairs 170a and 170c each return the same result (e.g., liquid level of 0.10 m or 3.94 inches) and the transmitter/receiver pair 170b returns a liquid level of 0.11 m or 4.33 inches, the average of the three liquid level values is 0.103 m or 4.07 inches. The combined output in this example is a bit above the most accurate transmitter/receiver pair readings but considerably less than the most inaccurate transmitter/receiver pair reading.

Likewise, in the example of FIG. 4 and in the aspect of tank wall thickness, the operation of radar transmitter/receiver pair 170c will vary from the operation of the radar transmitter/receiver pair 170b because of the variability of thickness of the top wall. Specifically, the top wall thickness at the location of transmitter/receiver pair 170c is smaller than the top wall thickness at the location of transmitter/receiver pair 170b. The radar return through the increased top wall thickness may be smaller or larger than the radar return through the decreased wall thickness because the transmission through a dielectric slab, like the plastic wall of the tank, depends cyclically on the slab thickness. Averaging detected values from the three transmitter/receiver pairs will reduce the impact of the variable wall thickness and any related distortion in the combined output 160.

Averaging measurements from all three radar transmitter/receiver pairs that have returns at a specified near range below a specified threshold in the example of FIG. 4 will eliminate any transmitter/receiver pair reading that is outside the threshold from the combined output 160. For example, the threshold may operate to eliminate the reading from the transmitter/receiver pair 170b in the example of FIG. 4 from the end output 160. This improves the accuracy relative to averaging all three transmitter/receiver pair values because the liquid level from transmitter/receiver pair 170b would be less accurate than the liquid level from transmitter/receiver pairs 170a and 170c due to the signal variance caused by buildup 120b. Because the radar return at the specified near range from the transmitter/receiver pair 170b would fall outside the threshold due to the stronger radar return from the solid/liquid buildup 120b, the end output 160 would be the average of the two transmitter/receiver pairs 170a and 170c that are not impacted by solid/liquid buildup. The specified near range at which the returns are evaluated for comparison to the specified threshold could be chosen to correspond to the typical range for returns from top wall of the tank or from the water/solids that build up on the top wall of the tank. The specified threshold for returns at the specified range could be theoretically calculated based on typical near range returns, expected operating conditions of the tank, and other pertinent factors. Likewise, the thresholds could be empirically determined to optimize accuracy of the sensor output 160 based on actual operating conditions. Aspects of machine learning can be incorporated to adjust the threshold over time and provide increasingly accurate results in the output 160.

Averaging measurements from all radar transmitter/receiver pairs that have liquid level measurements in an expected range is another way to avoid inclusion of a transmitter/receiver pair reading in the combined output 160 that would otherwise skew the result to become less accurate, without requiring a more complicated assessment of determining which of the sensed measurements are correct, or close to being correct, as opposed to sensed measurements that are not. For example, the expected range could be set to plus or minus 10% from the average detected liquid level by all transmitter/receiver pairs. As such, if one of the transmitter/receiver pair detected levels is 10% higher or lower than the average of the liquid levels from all transmitter/receiver pairs, it may be excluded from the combined output 160. For example, considering three transmitter/receiver pair liquid level readings of 0.100 m (3.94 inches), 0.106 m (4.17 inches) and 0.085 m (3.35 inches), with an average of 0.097 m (3.82 inches) the third transmitter/receiver pair could be excluded since it is 12% below the average. The combined output is therefore the average of only the first two transmitter/receiver pair readings or 0.103 m (4.06 inches). The combined output in this example is between the most accurate transmitter/receiver pair readings and is considerably more accurate than the most inaccurate transmitter/receiver pair reading.

As another example, an expected range for purposes of improving accuracy in the combined output 160 could be based on a previous combined output 160 at an earlier point in time. Intelligence could be built-in to the system to track liquid usage (i.e., rate of tank emptying or tank filling) over time and based on associated stored data, the processor 150 could determine an expected value for each iterative sensed value at a subsequent point in time.

For instance, if the combined output 160 from the last sensed iteration of a freshwater tank indicated a detected liquid level of 6 inches in the tank 100 and that an expected liquid usage rate would be 0.2 inches for the next hour, the liquid level in the tank would be expected to fall during that hour. If a liquid level reading from one of the transmitter/receiver pairs showed the same as the combined output liquid level from an hour previous (i.e., 6 inches), it would be excluded from the combined output when the other two transmitter/receiver pair readings both show lower liquid levels as expected. Likewise, if any of the transmitter/receiver pair readings show a higher liquid level than the previous reading that would likewise be an unexpected result, that liquid level would be excluded in the combined output 160. In a tank where the liquid level was expected to rise over time, similar expectations could be applied but in reverse (i.e., transmitter/receiver pair readings showing lower levels than previous detections or unexpectedly low liquid levels relative to prior detected levels could be excluded in the combined output 160.) Such considerations apply a logical rule of reason to transmitter/receiver pair readings as compared to one another and to previously determined combined outputs 160 over time.

Selecting only the liquid level measurement from the radar transmitter/receiver pair with the lowest near-range return effectively imposes a selection of the least corrupted reading from the three transmitter/receiver pairs. The lowest near-range return would correspond to the sensor that was least affected by localized conditions and associated variance in returned radar signals that tend to produce errors in the sensed result.

Selecting only the measurement that is closest to an expected measurement is another way to impose a selection of the most accurate reading from the three transmitter/receiver pairs, and to reject inaccurate transmitter/receiver pair readings. Expected measurements may be determined in the manner described above for purposes of selecting the closest measurement to an expected value. That is, an expected result could be based on historical data collected by the sensor system over time.

While the embodiment of FIG. 4 uses three radar sensors, it will be appreciated that the three spaced apart measurements could be obtained with a single radar sensor that switches between three different antennas or three different transmit/receive antenna pairs that are spaced apart from one another, for example in the positions of radar sensors 170a, 170b, and 170c in FIG. 4.

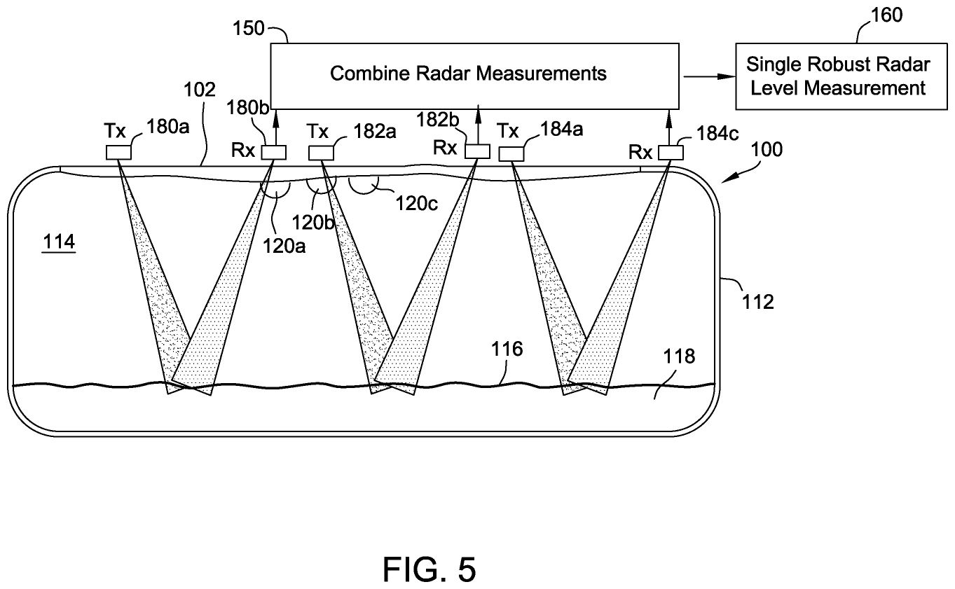

FIG. 5 illustrates a bistatic radar sensor implementation of the radar sensor system shown in FIG. 3 in accordance with an exemplary embodiment of the present invention. Three bistatic radar sensors are shown each including a transmitter/receiver pair in spaced relation from one another on the top wall 102 of the storage tank 100. Specifically, a first bistatic radar sensor includes a first radar transmitter 180a and a first radar receiver 180b, a second bistatic radar sensor includes a second radar transmitter 182a and a second radar receiver 182b, and a third bistatic radar sensor includes a third radar transmitter 184a and a third radar receiver 184b. Each transmitter/receiver pair is operable in the respective locations shown, with each transmitter/receiver pair producing different return effects due to variances in the top wall thickness of the storage tank and due to the presence or absence of liquid/solid buildup 120a, 120b, and 120c. Algorithmic signal processing techniques such as those described above may be applied on the respective radar measurements of each radar transmitter/receiver pair with similar effect by the processor-based device 150 to produce a combined output 160 with improved accuracy that can be reliably applied to take desired actions in response for the end output 160 of the detected liquid level in the storage tank 100.

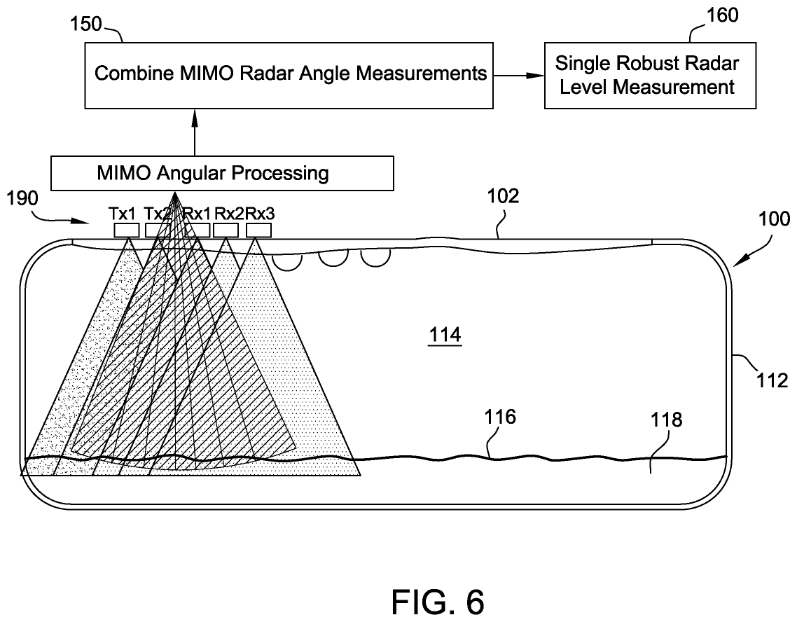

FIG. 6 illustrates a first multiple-input multiple-output (MIMO) radar sensor implementation of the radar sensor system shown in FIG. 3 in accordance with an exemplary embodiment of the present invention. A MIMO radar sensor 190 is shown having two radar transmitters Tx1 and Tx2 and three radar receivers Rx1, Rx2, and Rx3 at respectively different locations on the top wall 102 of the storage tank 100. The radar transmitters Tx1 and Tx2 transmit orthogonal signals that can be separated when received. This can be done by using respectively different (e.g., orthogonal) radar signals or by transmitting similar radar signals but at different times. The transmitters Tx1 and Tx2 transmit through the top wall 102, reflected signals of which may each be received by each respective radar receiver Rx1, Rx2, and Rx3. Known MIMO Angular Processing may be performed on the set of signals from each combination of a transmitter and a receiver and input into the processor-based device 150 for determination of a corresponding detected liquid level in the storage tank 100.

Algorithmic signal processing techniques such as those described above may be applied on the respective angle measurements with similar effect by the processor-based device 150 to produce a combined output 160 with improved accuracy that can be reliably applied to take desired actions in response for the end output 160 of detected liquid level in the storage tank 100. Specifically, the processor-based device 150 may combine the radar receiver outputs into a single output 160 using algorithms that apply one or more of the following operations in non-limiting examples of contemplated embodiments: (1) averaging measurements from all angles calculated from the combination of transmitters and receivers; (2) averaging measurements from all angles calculated from the combination of transmitters and receivers that have near-range return power below a specified threshold; (3) averaging measurements from all angles calculated from the combination of transmitters and receivers that are in an expected range; (4) selecting only the measurement from the angle calculated from the combination of transmitters and receivers with the lowest near-range return power; and (5) selecting only the measurement from the angle calculated from the combination of transmitters and receivers that is closest to an expected measurement.

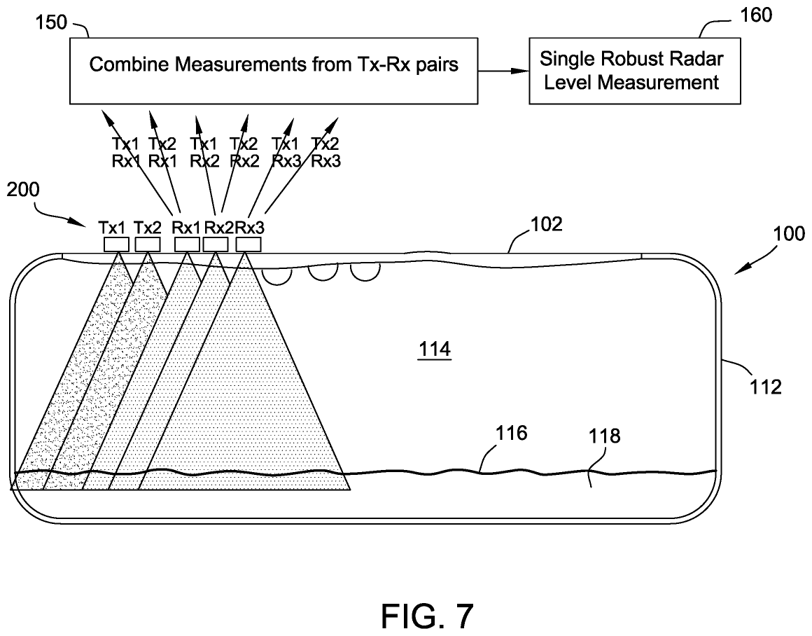

FIG. 7 illustrates a second multiple-input multiple-output (MIMO) radar sensor implementation of the radar sensor system shown in FIG. 3 in accordance with an exemplary embodiment of the present invention. A MIMO radar sensor 200 is shown having two radar transmitters Tx1 and Tx2 and three radar receivers Rx1, Rx2, and Rx3 at respectively different locations on the top wall 102 of the storage tank 100. The radar transmitters Tx1 and Tx2 generate respectively different radar signals and transmit them through the top wall 102, reflected signals of which may each be received by each respective radar transmitter Rx1, Rx2, and Rx3. Instead of MIMO Angular Processing, however, liquid level measurements are obtained from each of the received radar signals and input into the processor-based device 150 for determination of a corresponding detected liquid level in the storage tank 100. Since there are two transmitters and three receivers, a total of six liquid level measurements are taken and combined by the processor-based device 150 to produce the combined output 160 with improved accuracy. Of course, greater or fewer numbers of transmitters and receivers could be incorporated in another embodiment to provide varying numbers of liquid level measurements for consideration in determining the combined output 160.

Specifically, and as shown in FIG. 7, the six liquid level measurements include a first liquid level measurement from the transmitter/receiver pair Tx1 and Rx1, a second liquid level measurement from the transmitter/receiver pair Tx1 and Rx2, a third liquid level measurement from the transmitter/receiver pair Tx1 and Rx3, a fourth liquid level measurement from the transmitter/receiver pair Tx2 and Rx1, a fifth liquid level measurement from the transmitter/receiver pair Tx2 and Rx2, and a sixth liquid level measurement from the transmitter/receiver pair Tx2 and Rx3.

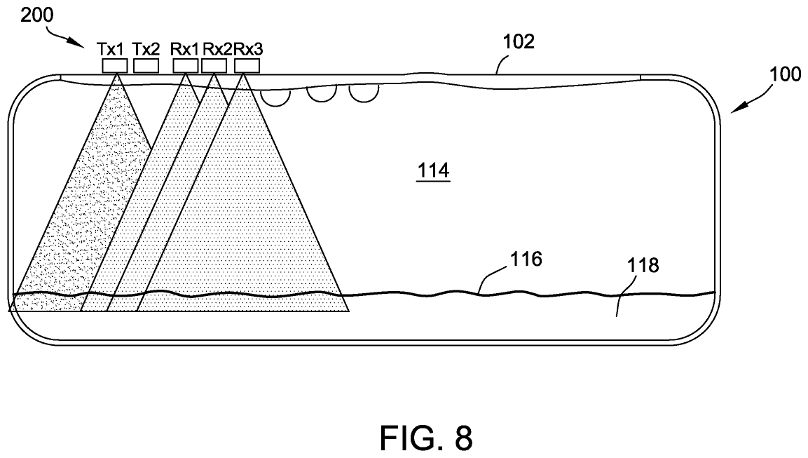

FIG. 8 illustrates an exemplary operation of a first portion of the MIMO radar sensor 200 with the transmitter Tx1 generating a radar signal that is transmitted through the top wall 102 and reflected back to the receivers Rx1, Rx2, and Rx3 through the top wall 102 to generate three liquid level measurements based upon the transmission from Tx1. With Tx1 transmitting, signals are received at Rx1, Rx2, and Rx3, and then the mathematical Fast Fourier Transform (FFT) is applied to convert the radar time domain signal into a frequency domain signal. In Frequency Modulated Continuous Wave (FMCW) radar systems, conversion from the time domain to the frequency domain provides range discrimination. As such FFT conversion in FMCW radar systems for range discrimination is well known in the radar industry, it is not described further herein.

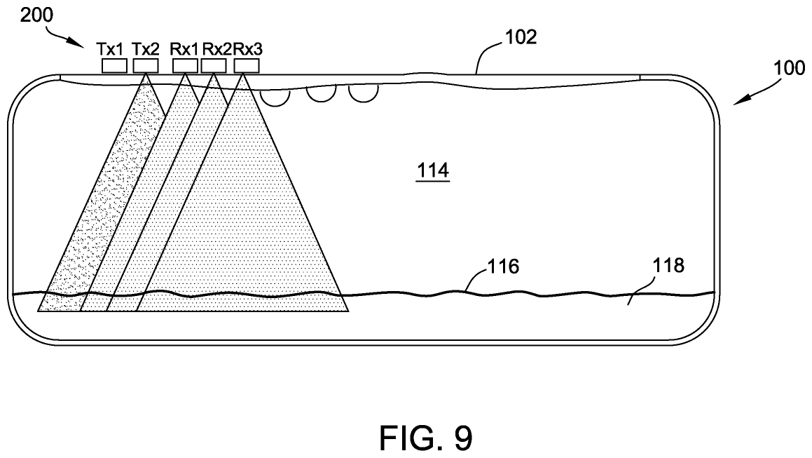

FIG. 9 illustrates an exemplary operation of a second portion the MIMO radar sensor 200 with the transmitter Tx2 generating a radar signal that is transmitted through the top wall 102 and reflected back to the receivers Rx1, Rx2, and Rx3 through the top wall 102 to generate three liquid level measurements based upon transmissions from Tx2. With Tx2 transmitting, signals are again received at Rx1, Rx2, and Rx3, and the range FFT is again computed.

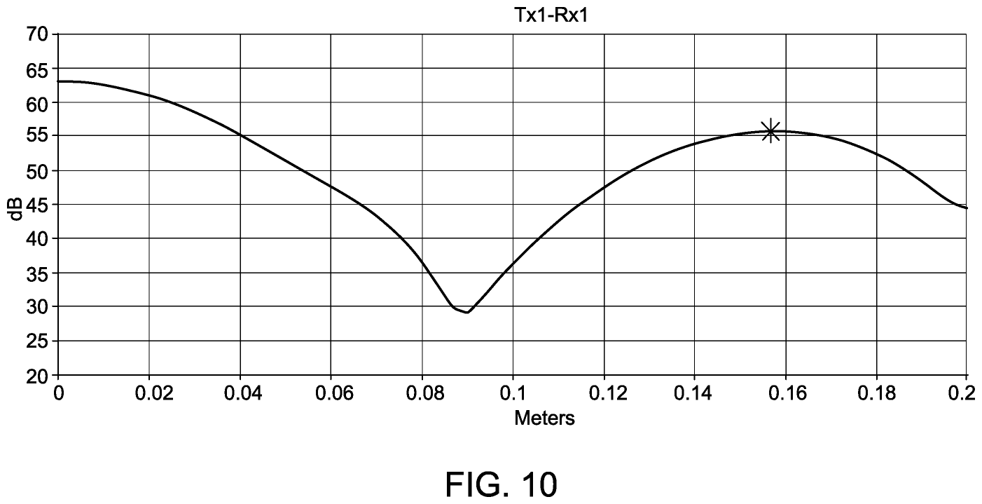

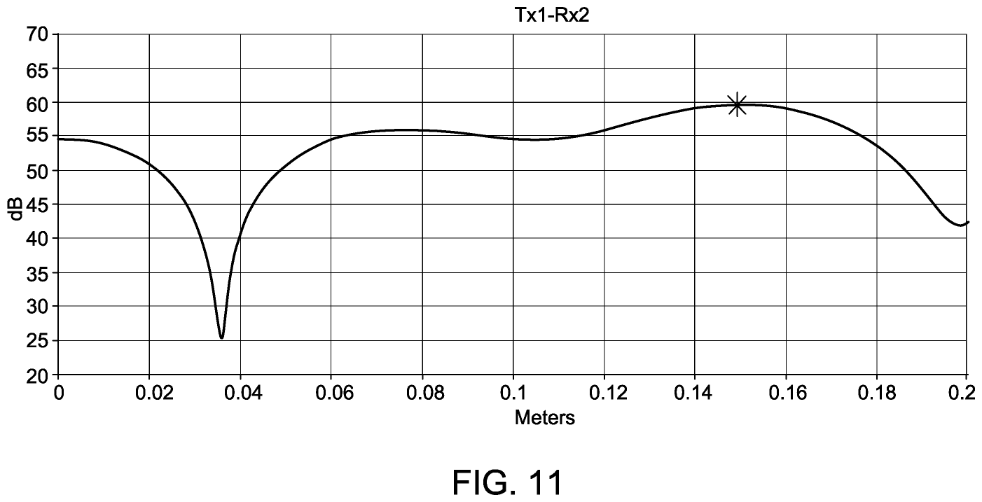

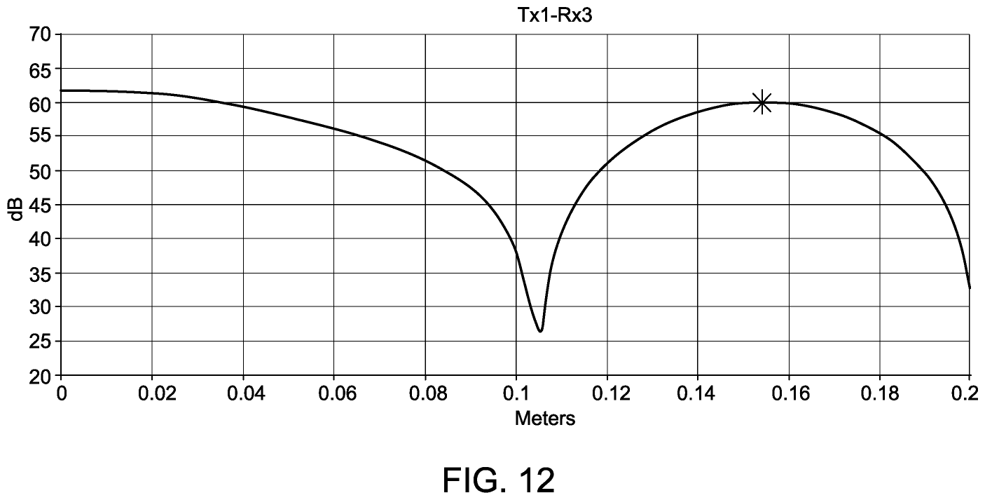

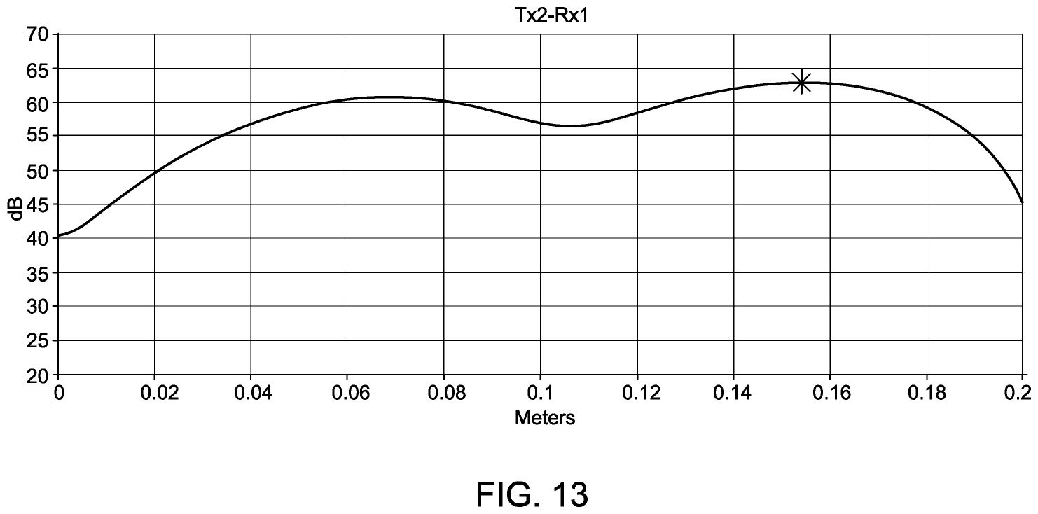

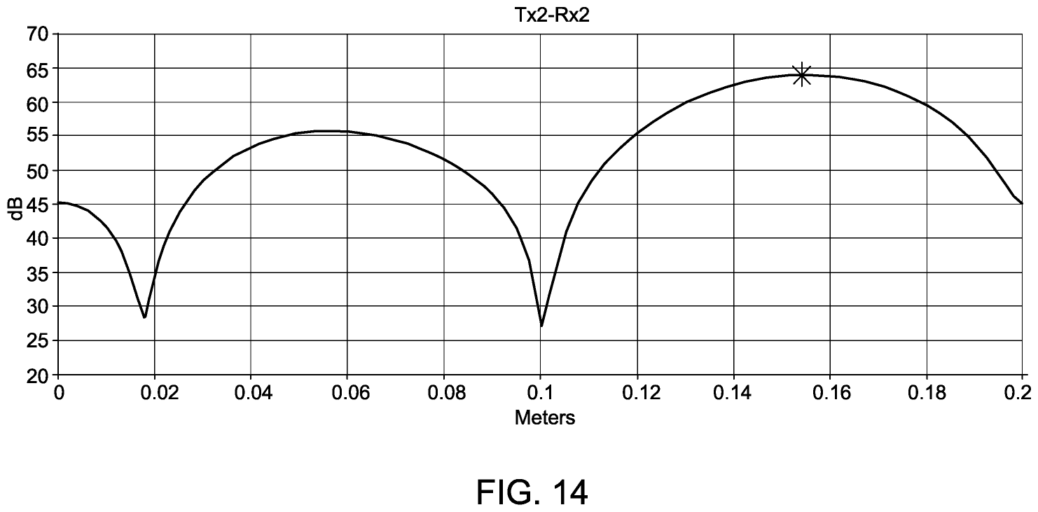

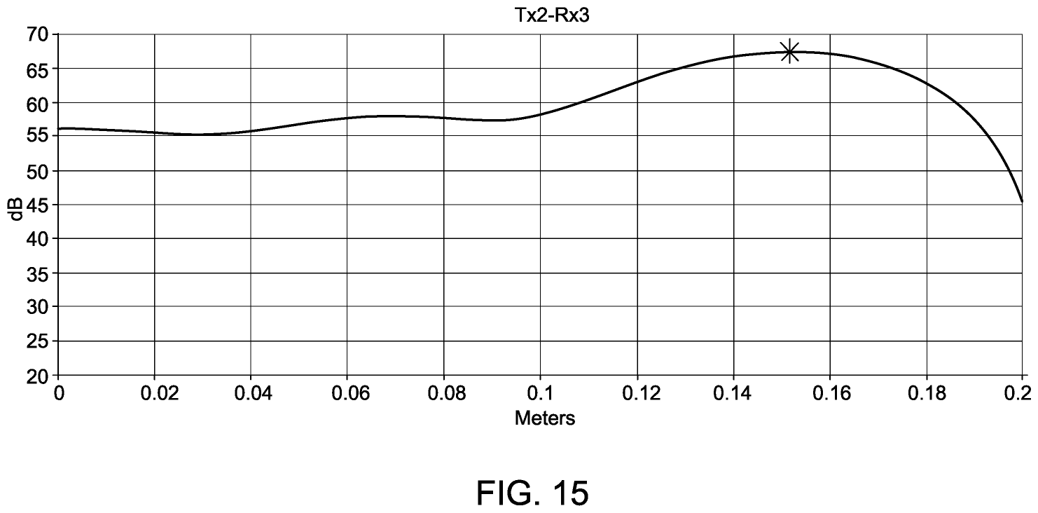

FIGS. 10-15 illustrate radar return power as a function of range which is calculated by converting the FMCW radar signals to the frequency domain. The plots in FIGS. 10-15 correspond to the liquid level measurements illustrated in FIGS. 7-9, wherein FIG. 10 is a radar power plot for the transmitter/receiver pair Tx1 and Rx1; FIG. 11 is a radar power plot for the transmitter/receiver pair Tx1 and Rx2; FIG. 12 is a radar power plot for the transmitter/receiver pair Tx1 and Rx3; FIG. 13 is a radar power plot for the transmitter/receiver pair Tx2 and Rx1; FIG. 14 is a radar power plot for the transmitter/receiver pair Tx2 and Rx2; and FIG. 15 is radar power plot for the transmitter/receiver pair Tx2 and Rx3.

A cursory review of the power plots shown in FIGS. 10-15 confirms the discussion above that the radar return obtained is sensitive to locations of the transmitters and receivers, and as such the six transmitter/receiver pairs return clearly different measurements that are explained by different near return effects at the particular locations of the receivers Rx1, Rx2, and Rx3 for each of the signal transmissions of Tx1 and Tx2. Algorithmic signal processing operations for the power plots to realize the desired combined output 160 (FIG. 7) may include the following.

As shown in each of FIGS. 10-15, the local maximum in radar return power as a function of range within the range of potential water levels for each transmitter/receiver pair may be determined. It is seen from the power plots that below about 0.1 meters the radar returns vary widely amongst the six measurements made from the respective transmitter/receiver pairs. This indicates different near range returns (or an absence of near range returns) in the different power plots and accordingly some of the radar power plots affected by near range returns may not be as reliable. In ranges beyond about 0.1 m, however, each of the six plots appear to converge within a relatively small band of values, and this convergence indicates a range of potential liquid levels that is likely to include the actual liquid level. The local maxima in this range are indicated with stars in FIGS. 10-15, with the corresponding power level at each local maximum and the range at which this local maximum occurs (the “position”) for each transmitter/receiver pair provided below in Table 1.

TABLE 1
Local Maximum and Power Level

| | Tx1 | Tx2 |
|---|---|---|
| Rx1 | Power Level: 55.6 dB | Power Level: 62.9 dB |
| | Position: 0.156 meters | Position: 0.154 meters |
| Rx2 | Power Level: 59.6 dB | Power Level: 64.0 dB |
| | Position: 0.149 meters | Position: 0.154 meters |
| Rx3 | Power Level: 60.0 dB | Power Level: 67.3 dB |
| | Position: 0.154 meters | Position: 0.152 meters |

For the purposes of the combined output 160, the six position values in Table 1 may be averaged. The averaged position of all of the tabulated transmitter/receiver pairs is 0.153 m so the combined output 160 returns a value of 0.153 m. This means that the surface 116 of the liquid inside the tank 100 is 0.153 m (6.02 inches) below the elevation of the radar transmitters and receivers above the top wall 102 of the storage tank 100, which can now be easily converted to a percentage of the tank capacity (i.e., x percent full or y percent empty) as desired.

For purposes of the operation of averaging measurements from transmitter/receiver pairs that have low near range returns to produce the combined output 160, the range of 0.09 m will be used as the range at which the near range returns are evaluated in comparison to a specified threshold. The power levels at range 0.09 m for each of the six transmitter/receiver pairs in the example power plots illustrated in FIGS. 10-15 are tabulated below in Table 2.

TABLE 2
Power Level at 0.09 meters

| | Tx1 | Tx2 |
|---|---|---|
| Rx1 | Power Level: 28 dB | Power Level: 58 dB |
| Rx2 | Power Level: 55 dB | Power Level: 47 dB |
| Rx3 | Power Level: 47 dB | Power Level: 57 dB |

The average power level of all six transmitter/receiver pairs, 48.7 dB, will be used as the specified threshold. It is seen that the power levels at the specified range of the Tx1 and Rx1, Tx1 and Rx3, and Tx2 and Rx2 transmitter/receiver pairs are below the specified threshold and are therefore deemed “low” near range returns. The remaining three power levels for the other three transmitter/receiver pairs in Table 2 are above the average power level and are therefore deemed “high” near range returns. The measurements from the transmitter/receiver pairs with high near range returns are accordingly excluded from the operation of averaging the measurements from transmitter/receiver pairs with low near range returns. As such, the position values in Table 1 for only the transmitter/receiver pairs with low near range returns, as shown in Table 2, are averaged. The average position obtained from the radar returns from these three transmitter/receiver pairs is 0.155 m (6.10 inches). So, the combined output 160 returns a value of 0.155 m.

Averaging measurements in an expected range for the six position values in Table 1 is as follows for purposes of the combined output 160. None of the position values is clearly disparate from the others by a sufficient amount to exclude it as an unreasonable or unexpected value. The difference between the highest position value (0.156 m for the Tx1-Rx1 pair) and the lowest position value (0.149 m for the Tx1-Rx2 pair) is 0.007 m (0.28 inches). This is a good result and none of the measured values of the transmitter/receiver pairs need be excluded. The average of the six position values is again 0.153 m (6.02 inches), so the combined output 160 returns a liquid level value of 0.153 m.

Selecting only the measurement with the lowest near range return for purposes of the combined output 160 is as follows. Referring to Table 2, the Tx1-Rx1 pair has the lowest return at a position of about 0.09 m. The local maximum position (0.156 m) for the Tx1-Rx1 pair is therefore selected for purposes of the combined output 160, so the combined output 160 returns a liquid level value of 0.156 m.

Selecting the measurement closest to an expected range for purposes of the combined output 160 is as follows. Based on prior measurements and/or on water usage data over time, the processor-based device returns an expected measurement of 0.152 m as a baseline to which the transmitter/receiver pair measurements are compared. It is seen from Table 1 that the Tx2-Rx3 pair has a local maximum return at a position of 0.152 m (5.98 inches) in the potential range of values for actual liquid level. The Tx2-Rx3 measurement is therefore selected and the combined output 160 returns a liquid level value of 0.152 m.

The astute reader will note that the different types of processing described above upon the transmitter/receiver pair power outputs for purposes of the combined output 160 returns a set of values from 0.152 m to 0.156 m despite the fact that the Tx1-Rx2 pair indicates a 0.149 m liquid level. In the exemplary set of transmitter/receiver pair liquid level measurements in Table 1, the Tx1-Rx2 pair is the most affected by localized conditions that produce signal error and therefore is the least accurate value, and each of the techniques above reduces, if not entirely eliminates, the influence of the Tx1-Rx2 pair in the combined output 160.

While exemplary types of algorithmic operations are described above to produce a combined output based on the returns of the various transmitter/receiver pairs provided, variations are of course possible and other transmitter and receiver combinations and other algorithmic operations could be implemented to realize otherwise similar advantageous effects. For example, instead of averaging detected liquid level values, the averaging could be performed on the radar return power as a function of range, and then the detected liquid level could be determined from the average radar return power. Additionally, one of skill in the art will recognize that similar techniques can be used with a radar sensor that has multiple transmitters and a single receiver (multiple-input single-output or MISO) and a radar sensor that has a single transmitter and multiple receivers (single-input multiple-output or SIMO). In such implementations, the radar sensor arrangements would have different numbers of transmitters and receivers but the algorithms used to produce the desired results would be similar.

Specifically, the above exemplary MIMO radar sensor arrangement described above has two transmitters and three receivers. A MISO sensor arrangement could also be realized by omitting two of the three receivers of the MIMO sensor arrangement (resulting in two transmitters and a single receiver), while a SIMO sensor arrangement could be realized by omitting one of the two transmitters of the MIMO sensor arrangement (resulting in a single transmitter with three receivers). In these examples, the MIMO embodiment would generate six radar returns while the MISO and SIMO arrangements would respectively generate two and three radar returns. However, in all embodiments, the radar returns would be similarly processed to determine the single liquid level output. Of course, three MISO sensor arrangements or two SIMO sensor arrangements could be utilized to generate six radar returns if desired. Combinations of MIMO, MISO and SIMO sensor arrangements are likewise possible to reliably detect liquid levels for the same or different liquid storage tanks.

In yet another contemplated sensor arrangement, a single radar transmitter and a single radar receiver may be connected to a plurality of antennas to obtain a plurality of radar returns with different localized effects that could be combined into a single liquid level detection output with similar algorithmic processing to that described above. More than one such sensor arrangement could be provided on the same or different liquid storage tank, as well as in combination with MIMO, MISO and SIMO arrangements described above.

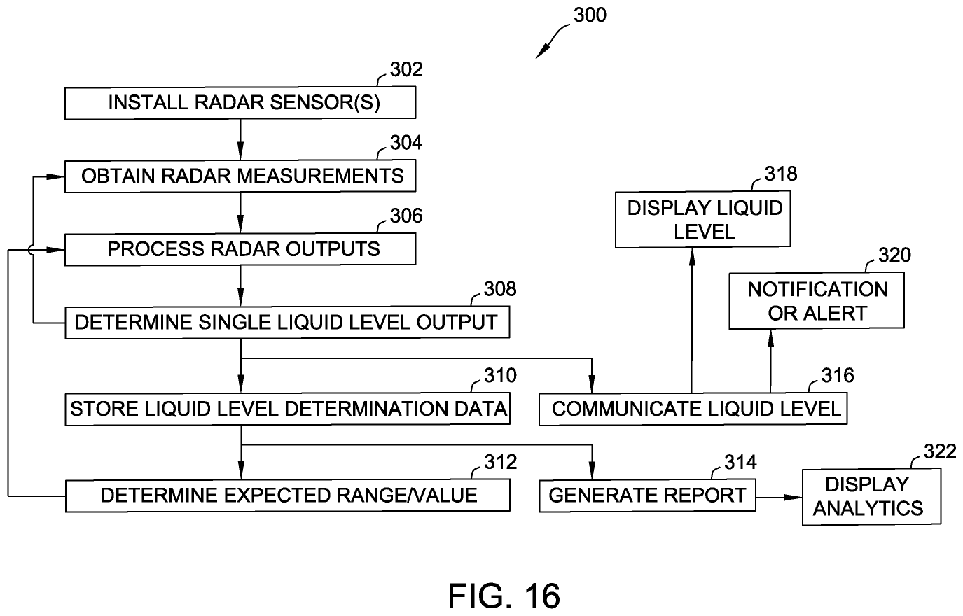

FIG. 16 illustrates exemplary method process 300 of determining liquid level in a storage tank such as the storage tank 100 utilizing the radar sensor systems and implementations of FIGS. 3-9 and operating upon radar transmitter/receiver pair power outputs such as those illustrated in FIGS. 10-15.

As a preparatory step 302, the radar sensors with their respective transmitters and receivers are installed in distributed locations upon a liquid storage tank to be monitored.

For purposes of step 302, the storage tank may be the storage tank 100 described above in relation to FIG. 1, although the benefits of the inventive method do not necessarily depend on the storage tank 100 and instead could be applied to other types of liquid storage tanks. The radar sensors may correspond to any of the sensor arrangements described above (e.g., monostatic radar sensors, bistatic radar sensors, multiple-input multiple-output (MIMO) radar sensors, etc.) with transmitters and receivers that are distributed across and operating upon various different locations on the exterior top wall of the storage tank 100 as described above. Such a distribution of radar transmitters and receivers at various different locations with respect to the storage tank reduces measurement errors due to localized effects that produce returned radar signal variation in the operation of one or more of the transmitters and/or receivers which could otherwise lead to inaccurate liquid level measurement.

In some embodiments the separation between transmitters and/or receivers may simply be on the order of the size of the antennas. For example, the separation may only be about 0.1 in (0.25 cm). Even this small separation in transmitters and/or receivers is effective in achieving improved performance since the size of water droplets or the size of accumulated solids in the storage tank are also small.

Installation of the radar sensors for purposes of step 302 may include mounting the radar sensors in a fixed position to the top wall of the storage tank in any suitable manner, including but not necessarily limited to bonding of the sensors to a surface of the top wall with an adhesive in solid or liquid form, such that the radar transmitters and receivers are operative to transmit and receive radar signals through the top wall without requiring openings to facilitate radar transmissions.

Alternatively, however, in some cases step 302 could include forming openings in the storage tank and aligning the radar transmitters and receivers with the openings to facilitate radar signal transmission through such openings. Such openings could in some cases be preformed in the storage tank. Any openings in the storage tank would of course need to be appropriately sealed as an aspect of sensor installation.

In other contemplated embodiments, the radar sensors may be mechanically mounted in spaced relation from the exterior top wall of the tank, without necessarily being in surface contact with the storage tank as desired. In still other possible embodiments, radar sensors may be mounted on an interior surface of the top wall of the tank provided that they are properly sealed and protected.

Also for the purposes of step 302 the sensors are interfaced with other liquid level detection system components such as the processor-based device 150, as well as other devices receiving the combined output 160 from the processor-based device 150. The sensors, processor-devices, and other devices may communicate via wired or wireless communication paths utilizing predetermined communication protocols.

At step 304, the radar sensors and associated transmitters and receivers are operated to produce multiple radar return measurements made by different transmitter/receiver pairs or transmitter/receiver combinations. Radar returns such as those illustrated in graphical form in FIGS. 10-15 may be generated. The radar returns are collectively input to a separate processor-based device 150 (FIGS. 3-7) in exemplary embodiments to assess the measurement made by the transmitter/receiver combinations relative to one another.

At step 306 the radar returns are processed in the manner described above in relation to, for example, FIGS. 4-9 and the example returns of FIGS. 10-15 to process and produce the combined, single liquid level output at step 308. The processing for step 308 may be made by the processor-based device 150 that receives the respective radar returns and applies one or more of the techniques described above to mitigate the influences of localized conditions that render one or more of the measurements from the transmitter/receiver combinations to be less accurate. The determined, single liquid level output at step 308 corresponds to the output 160 in FIGS. 3-7.

Once the single liquid level output is determined at step 308, the system returns to step 304 and obtains further radar measurements. The system and method are therefore iteratively operable to successively obtain and process radar measurements to determine a sequence of single liquid level outputs over time. With each iteration, the determined single output may be stored at step 310 with any supporting data desired. The stored data from step 310 may be analyzed and used to determine expected ranges of liquid level or expected values of liquid level at step 312 that may serve as baselines to evaluate the data sets at step 306. Steps 310 and 312 provide intelligence regarding liquid usage and corresponding depletion or filling of the storage tank being monitored that may provide a degree of machine learning to become more accurate over time based on actual, historical usage of liquid and patterns of liquid usage that may provide for more meaningful assessment of the data sets at step 306.

Detailed report generation at step 314 is also possible including logged and archived data for review and study of sensor system operation and liquid usage. Such data and report generation may provide insight for a more proactive management of liquid usage as well as to further refine, diagnose or troubleshoot the radar sensor system in view of the data collected. For purposes of report generation at step 314, such reports could be displayed in summary analytic form as shown at step 322 to an interested person on a display screen at any desired location aboard an RV, food truck, or recreational boat, for example. Such report generation may likewise entail printed reports and more detailed data outputs which may be analyzed on another device in further and/or alternative embodiments for system diagnostics and troubleshooting, for liquid usage study and management, or for any other suitable purpose.

As also shown in FIG. 16, as each single liquid level output is determined at step 308, the liquid level output is communicated in a wired or wireless manner to another device where it can be displayed at a convenient location for the benefit of an end user at step 318. Such display may be made via a video monitor or other display screen that may also display a variety of information other than liquid level which may pertain to other aspects of a vehicle system or other system that includes the storage tank being monitored. The display screen in some embodiments may be a touch-sensitive display screen that is located remotely from the storage tank. Such touch-sensitive display may be mounted at a fixed location in a vehicle, or in other cases may be associated with a user device such as a smartphone or tablet computer of the interested owner/operator of the system including the monitored storage device. As such, the display for purposes at step 318 may correspond to different devices having different display screens for access by the same or different persons.

As shown at step 320, notifications or alerts may also be generated based on the value of the last determined liquid level output at step 308. The alerts or notifications can include audio, visual and/or tactile components to garner attention of interested persons who may take appropriate actions in response. The notifications and alerts may be made via different devices at different locations, and such notifications and alerts may be escalated as the liquid level output at step 308 corresponds to critical levels indicating a nearly depleted tank or a nearly full tank that could render the associated system (e.g., a vehicle system) inoperable in a key aspect due to an empty tank or full tank. Data concerning notifications and alerts generated at step 320 could be logged and archived with supporting data and included in report generation at step 314 for further review and study to evaluate the effectiveness of the system.

Having described devices and applicable operating algorithms functionally per the description above, those in the art may accordingly implement suitable algorithms via programming of the processor-based computing devices. Such programming or implementation of the concepts described is believed to be within the purview of those in the art and will not be described further.

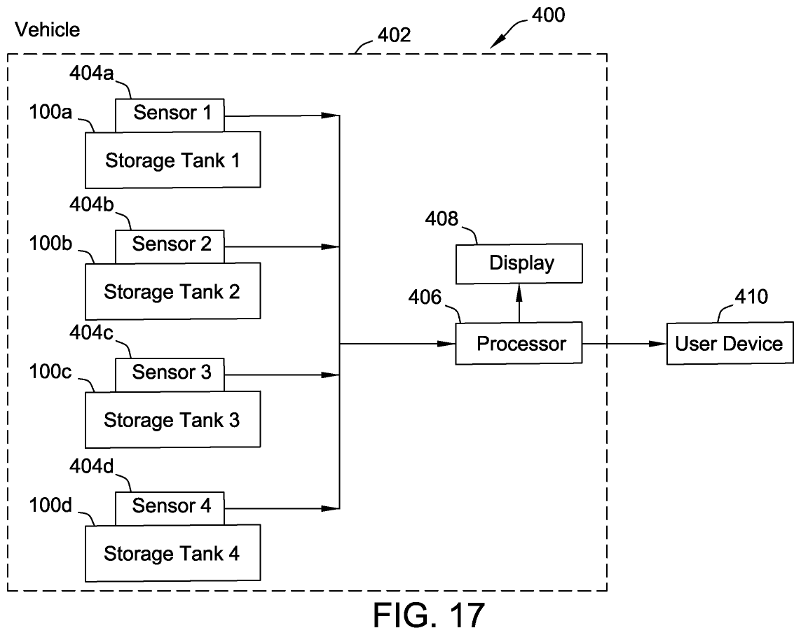

FIG. 17 schematically illustrates a radar sensor liquid level detection system 400 in accordance with an exemplary embodiment of the present invention.

The sensor system 400 is applied to a vehicle 402 including multiple storage tanks 100a, 100b, 100c, and 100d. The storage tank 100a may be a freshwater tank supplying water to one or more locations in the vehicle system. More than one freshwater tank may be provided at the same or different locations in the vehicle 402. The storage tank 100b may be a grey water tank which collects water used in, for example, a lavatory sink or shower in the vehicle 402. The storage tank 100c may be a galley tank which is a specific grey water tank which collects water from a kitchen sink or a kitchen appliance in the vehicle 402. The storage tank 100d may be a black water tank which collects water including human waste from toilet flushing. More than one grey water and/or black water storage tank may be provided at the same or different locations in the vehicle 402, and still other liquid storage tanks may be included in the vehicle 402 that do not relate to water use, including but not limited to fuel tanks including gasoline, diesel fuel or propane as non-limiting examples of liquid that could also benefit from the radar monitoring systems described. The vehicle 402 in contemplated embodiments may be a recreational vehicle (RV), a food truck, a recreational marine vehicle or boat, or a semi-truck including living quarters for a driver.

Each tank 100a, 100b, 100c, and 100d is respectively equipped with radar sensor systems 404a, 404b, 404c, and 404d that each include transmitters and receivers as described above in relation to FIGS. 3-9 to provide multiple radar-based liquid level measurements for each tank. The radar returns for a combination of measurements made for each tank are input to a centralized processor device 406. The centralized processor device 406 implements the pertinent steps of the method 300 upon the radar returns for each corresponding tank to determine a single liquid level output for each respective tank in a manner that improves accuracy per the description above. Once determined, the single liquid level output for each tank can be communicated and displayed on a central control display 408 in a cabinet having a prominent location and visibility in the vehicle 402. The display 408 in some cases may also include a dashboard display or infotainment display for the vehicle that may be observed by a driver of the vehicle while the vehicle is in transit.

The single liquid level output for each monitored tank in the vehicle 402 may also be sent to or retrievable from user devices 410 such as smartphones for users that may not be in the vehicle, tablet computer devices that may be present in the vehicle, laptop or notebook computers, or desktop computers as preferred by interested users. Notifications, alerts and alarms may be generated via any of the devices described to command attention of users inside or outside of the vehicle of important liquid level detection events once the emptiness or fullness of the tanks crosses predetermined thresholds.

The system 400 is generally scalable to a number n of storage tanks 100 storing or collecting different liquids in the vehicle which may be monitored simultaneously with improved accuracy. While illustrated and described in relation to a vehicle 402, the benefits of simultaneous monitoring of multiple tanks with a single processor 406 and reported on a centrally located display 408 or via a user device 410 are not necessarily limited to vehicle use.

In the monitoring system and methods of the invention, a plurality of independently operable sensor elements provide combinations of liquid level detection data outputs that are processed continuously, periodically, or on demand into meaningful informational analytics for interested persons to more readily understand a real-time status of liquid supplies in monitored storage tanks, liquid utilization rates and expected timeframes until tanks are full or empty, and implement countermeasures to more effectively manage liquid resources to avoid empty tanks or full tanks at times or locations where they may not be refilled or emptied for further use. The systems and methods of the invention may also advantageously suggest or recommend countermeasure actions to conserve liquid usage and may also automatically undertake countermeasure actions to shut off devices through which liquid (e.g., water) is consumed.

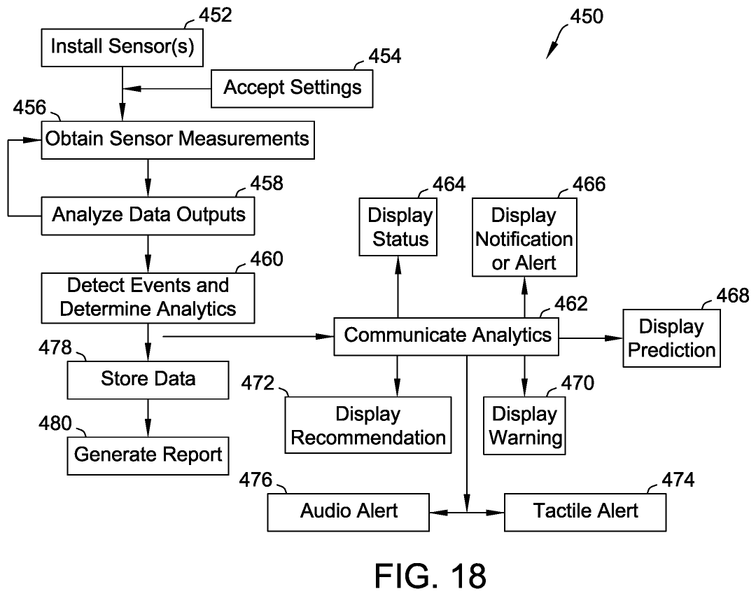

FIG. 18 illustrates exemplary algorithmic processes 450 for analytical monitoring and management of liquid usage based on operation of the sensor system 400 shown in FIG. 17 including storage tanks and sensors such as those shown and described in relation to FIGS. 2 through 9. The processes 450 are also generally applicable to storage tanks that may or may not be a vehicle-based storage tank as described above, as well as applicable to a single (i.e., only one) storage tank whether vehicle-based or not.

As a preparatory step 452 the sensors are installed on the respective storage tanks of interest. Step 452 also includes calibration of the installed sensors as appropriate to sense the liquid level in the tanks for purposes of the systems 400.

Also as a preparatory step 454, settings may be accepted for centrally located processor device 406 (FIG. 17) or another processor. Such settings may include: tank identifiers for each tank being monitored; identifiers for devices that dispense liquid or collect liquid for the tanks being monitored; limits or thresholds applicable for detection of certain liquid usage events; limits or thresholds for tank status or liquid usage that trigger alerts or notifications from the system; preferences for notifications or warnings generated by the system; preferences for certain time-based analytics generated (e.g., minutes, hours or days); communication preferences including contact information for users and/or user devices receiving communications; and other items of interest or data needed to realize the functionality described herein. The technical effect and technical features of the analytics and communications described herein are realized via the particular settings selected for operation of the system or the settings adopted in the implementation of the system that define the pertinent parameters for processing of the data outputs from the liquid level detection sensors.

At step 456, sensor measurements of liquid levels are obtained and at step 458 the sensor output data is analyzed. Steps 456 and 458 are iteratively executed continuously or on a periodic interval (which may be a selected setting in step 454) either of which accumulates data sets of liquid level measurement that are chronological and successive from the operation of the sensors over time. Such chronological data sets over a sufficiently long time period may be analyzed to detect specific types of liquid usage events and associated analytics as shown at step 460. Such detections and analytics, in turn, provide for proactive liquid use management when desired or as needed.

Detected events at step 460 may include: tank emptying or tank filling that is considered normal and which does not rise to a level of concern; critical events of concern where tank emptiness or tank filling crosses notification and alarm threshold; excessive liquid usage events in a predetermined time period; a leaking tank via sustained emptying of a tank over a longer period of time; tank refilling events for empty tanks; tank emptying events for full tanks; and other events serving the purposes of the system to educate end users on the state of liquid storage and afford the end users a proactive opportunity to make informed decisions to avoid adverse effects of full or empty tanks at inopportune times. The detected events at step 460 may operate according to accepted settings from step 454 to adjust the sensitivity of the system in operation in detecting events via changing the limits, thresholds, and other parameters that may render the system more or less sensitive to detecting events.

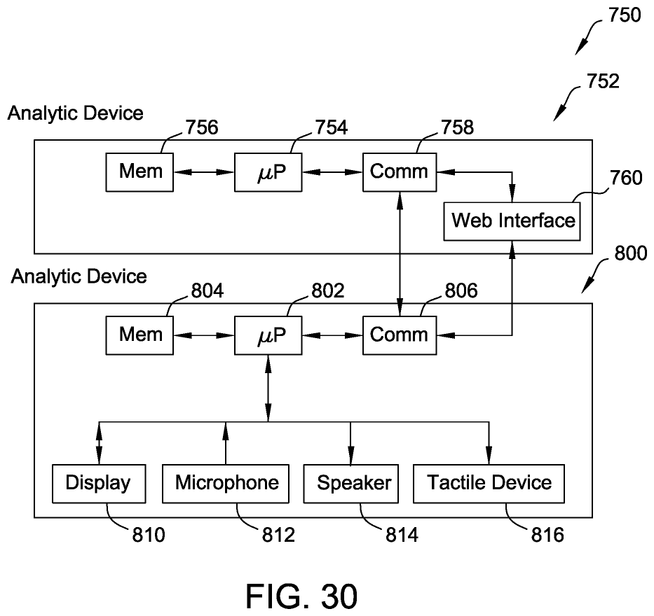

Analytics are also determined at step 460. The analytics are based on the iterative data collection and analysis from steps 456 and 458, and as the data changes the analytics also change. In view of the collected data and/or detected events, the generated analytics capture tank storage information and/or liquid usage information of interest that (i) the interested end users may not otherwise be aware of and that (ii) informs practical decisions that the interested end user may make concerning more optimal water usage in view of tank refilling or tamp emptying constraints. Machine learning techniques can be implemented at step 460 to identify patterns in historical data that can be further utilized to interpret and distinguish normal and abnormal liquid use based on historical data, realizing even further types of detected events and analytics that may be flagged for interested users. In contemplated exemplary embodiments, the determined events and analytics may be determined by the processor 754 (FIG. 30) or processor-based device 406 (FIG. 17) in a manner that does not depend on the circuitry of the sensor(s) involved in monitoring the tanks. If desired, however, the determined events and analytics may be determined by processors included with the circuitry of the sensors involved in monitoring the tanks.

As demonstrated in the examples below, the analytics are relatively simple and intuitive yet informative. The analytics are automatically generated and updated over time and are continuously or periodically reported on the system for reference by interested persons and/or may be accessed on demand by interested persons.

At step 462 the analytics are communicated via wired or wireless paths to any of the displays or computing devices of interested users (e.g., smartphones or tablet computer devices). The communications including generated analytics may include a display of current status of the monitored tanks at step 464, a display of a notification or alert at step 466, a display of a predicted event at step 468, a display of a warning at step 470 and/or a display of a suggestion or recommendation in view of the analysis and determined analytics as shown at step 472. Exemplary graphical screen displays for the visual displays of step 464, 466, 468, 470 and/or 472 are described below. Tactile alerts (e.g., vibration) and/or audio alerts may also be provided, separately or in combination with the visual displays as shown at steps 474 and 476. Audio and tactile components may attract or otherwise garner a heightened degree of attention or concern to communications made.

At step 478 data may be stored regarding detected events and communications. The stored data at step 478 may include supporting data for the detected events and analytic generation for study and review.

At step 480, reports may be generated based on and/or including data stored at step 478 for review and assessment of system operation, diagnostics and troubleshooting as well as informational study and review by interested persons regarding liquid usage in a much more detailed manner than provided by the analytics communicated in step 462. The reports may be provided in any form desired.

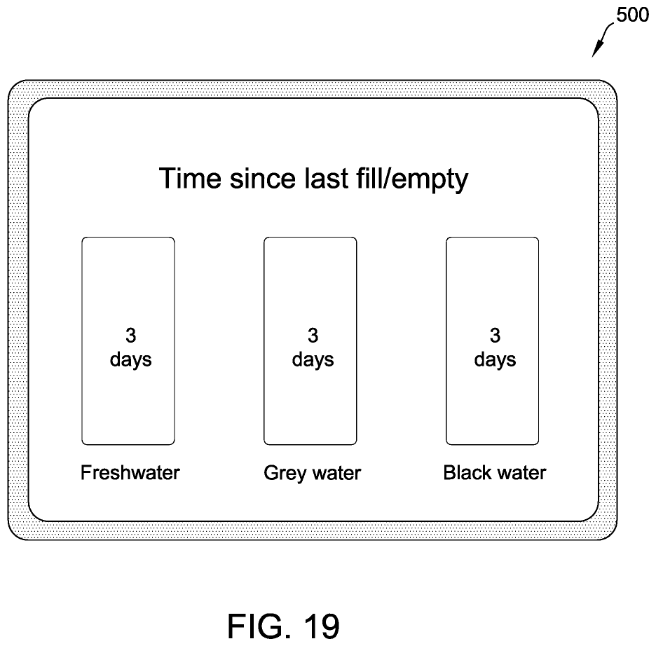

FIGS. 19-29 illustrate exemplary user interface graphical screen displays including analytics and management features for proactive water usage relating to water storage tanks in a vehicle system such as an RV or similarly situated vehicle described above. Such screen displays may be adapted for similar purposes to provide similar analytic and management effects for other liquids and storage tanks in a vehicle system (e.g., fuel in a fuel tank), as well as various types of liquids and storage tanks for the same that are not part of a vehicle system.

FIG. 19 illustrates a first exemplary user interface graphical screen display 500 including fill/empty storage tank analytics generated by the processes 450 illustrated in FIG. 18 and implemented in the system 400 (FIG. 17). As shown in the screen display 500, elapsed time since the most recent tank emptying for a collection tank (i.e., time of last pumping the contents out of the tank for disposal) or tank filling for a dispensing tank (e.g., filling of a freshwater storage tank) is shown for three tanks corresponding to a freshwater tank, a grey water tank, and black water tank of a vehicle system. The metrics shown in the screen display 500 may correspond to detected events with the sensors or may reflect a reset that is part of a tank filling or tank emptying procedure.

The screen display 500 can be a useful reminder for the interested person who, based on the analytics shown may have an educated guess how many days it will be before the tanks will need to be refilled or emptied. In a contemplated variation of the screen display 500 a predictive analytic could be displayed, separately or in sequence with the screen display 500, showing another analytic corresponding to a projected time until each tank will need to be refilled or re-emptied. Such predictive analytics could be calculated based on historical data concerning liquid usage and liquid usage rate at the time of the analytic generation.

While the display 500 shows the analytics in terms of days, it could alternately display the analytics in terms of hours or any other time period. While the analytics for the three tanks shown in the example display 500 are similarly depicted they could be different from one another. Greater or fewer than three tank analytics could be provided in a similar screen display.

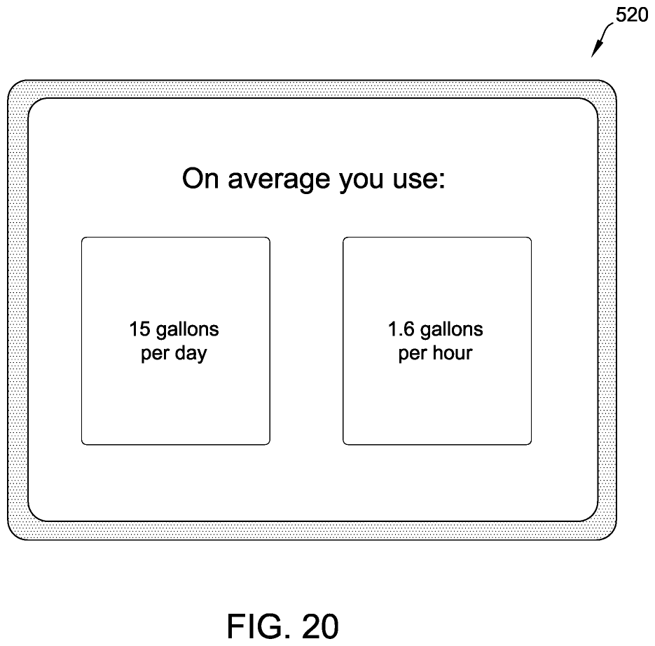

FIG. 20 illustrates a second exemplary user interface graphical screen display 520 including daily and hourly liquid usage summary analytics generated by the processes 450 illustrated in FIG. 18 and implemented in the system 400 (FIG. 17). Average liquid usage is shown in the display 520 over two different timespans, namely per day and per hour. The analytics shown may correspond to, for example, dispensed liquid from a freshwater storage tank. When the screen display 520 is regularly reported, the interested user will intuitively see the usage rates over the course of hours and days, and if desired may adjust liquid use if the reported analytics are undesirably high from the user's perspective. While volume of liquid per time period is shown in the example of FIG. 20, a proportional amount of tank capacity could be reported instead by fraction or by percent to give the end user a firm idea of the rate of liquid usage for monitored tanks.

The screen display 520 may optionally include a suggestion or recommendation that relates to the analytics reported. For example, based on the analyzed data and analytics, the system may report the following exemplary suggestion as a form of time-based feedback to the user: “You use most of your water from 5-8 pm. Consider halving your water flow at [sink name].” The system may likewise report the following event-based feedback as an exemplary suggestion to the user in another example: “Most of your water is used by your shower. Consider turning the water off when you lather.” Such feedback may be explicitly identified as a suggestion or recommendation in a screen display, but is intended to provide helpful data-based liquid conservation tips that are tailored so specific liquid usage considerations of different persons. In some embodiments, suggestions or recommendations could be made by the system when prompted by a user with an appropriate selector that is manipulated by the user. Suggestions may therefore be provided on demand or upon request by the user or as part of the feedback provided by the system to the end user.

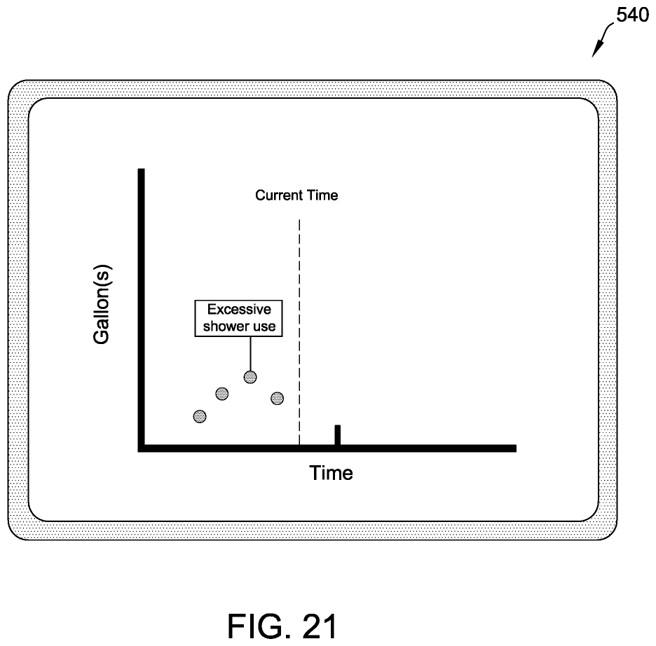

FIG. 21 illustrates a third exemplary user interface graphical screen display 540 including elapsed liquid usage analytics generated by the processes 450 illustrated in FIG. 18 and implemented in the system 400 shown in FIG. 17. The screen display charts liquid usage along a vertical axis and time along the horizontal access as shown. A series of water usage events are shown in chronological order in the example screen display 540, with one of them being identified as excessive shower use. Because the system 400 is connected to identified water use devices which may include the shower, the system can specifically identify which of the water use devices 126 are used excessively (i.e., involve liquid use that exceeds a predetermined threshold in a predetermined timeframe). Explanation, suggestion or recommendation may also be provided that relates to the excessive liquid usage event.

Also, in the example screen display 540, water usage events are self-populating as they occur throughout a passage of time. A current time is shown in dashed lines with a vertical line in the chart, and as time passes the vertical line advances to the right in FIG. 21 and shows additional detected water usage events with additional indications of excessive usage events. Screen displays of this type can show accumulated water usage events over the course of a morning, over the course of an afternoon, over the course of an evening, or over the course of a day. Via the screen display 540, the interested person can quickly and intuitively understand the frequency and amount of liquid usage by event and can make adjustments to reduce or possibly eliminate the occurrence of excessive liquid usage events. Multiple displays similar to that shown in the display 540 can be generated and shown to interested users in the course of a trip, for example, so that the user can compare the liquid usage on different days and if needed take corrective measures to conserve liquid usage.

Other types of analytics (e.g., running average per hour, or particular times when excessive liquid usage events were detected or when particular warnings were generated) may be generated and provided in screen displays similar to the screen display 540 so that an end user may see and understand water usage as the day progresses. Display of particular warning times may allow a user to distinguish between two shower events by different persons otherwise occurring in the same time interval (e.g., one hour). As another example, if multiple sinks are provided, display of warning times can be helpful for interested users to distinguish different use of the sinks by the same or different persons and associated water usage events.

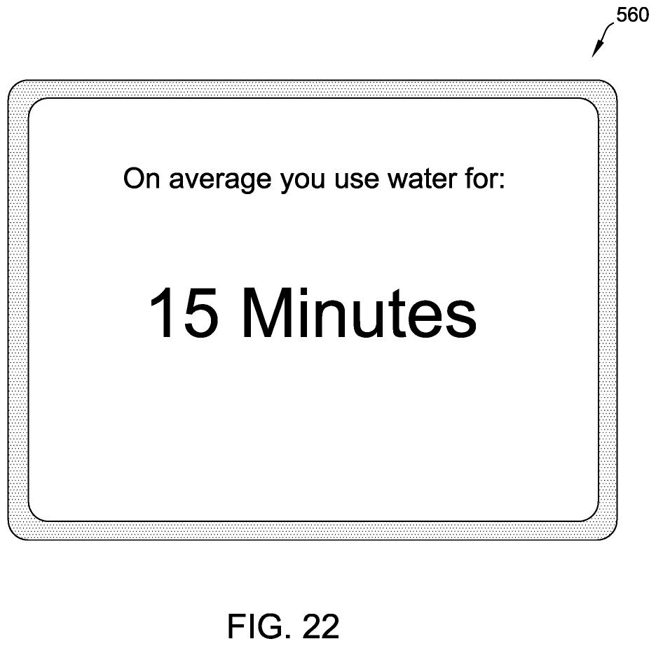

FIG. 22 illustrates a fourth exemplary user interface graphical screen display 560 including periodic liquid usage analytics generated by the processes 450 illustrated in FIG. 18 and implemented in the system 400 shown in FIG. 17. The screen display 560 shows average duration of a detected liquid use event. This is a variation of the screen display 520 (FIG. 20), but provides another reference for an interested user to make adjustments if the analytic provided seems higher than it should be (or could be). If the user chooses to take steps to reduce the average water use duration from the level shown, the use rate of tank emptying and tank filling would be lowered by a corresponding amount. The system may assist with suggestions and recommendations for the most practical ways to lower water usage based on the data sets and analysis performed by the system.

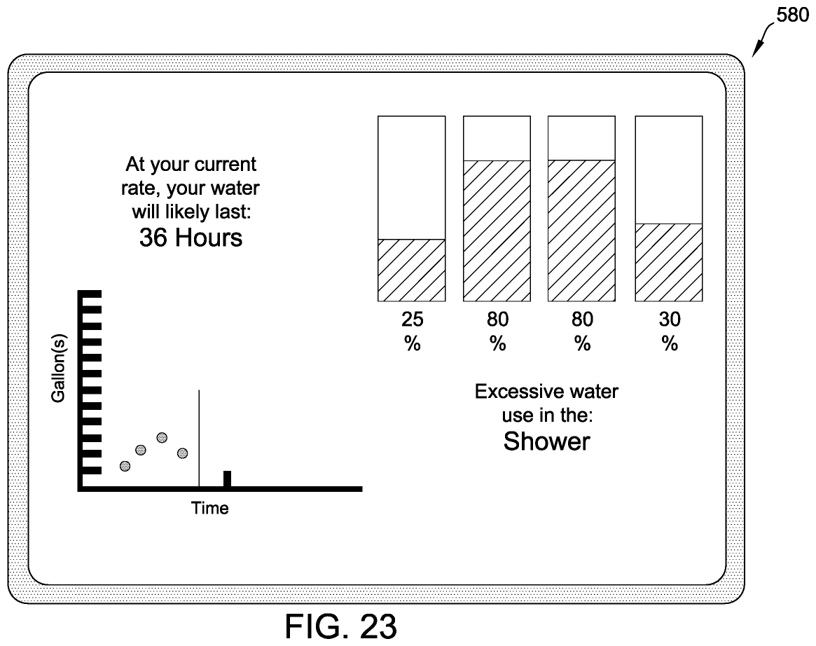

FIG. 23 illustrates a fifth exemplary user interface graphical screen display 580 including a combination of different analytics generated by the processes 450 illustrated in FIG. 18 and implemented in the system 400 shown in FIG. 17. The combination of analytics in the example shown includes a predictive analytic (e.g., time until the tank is empty) in the upper left quadrant, elapsed water usage events (similar to that shown in the display 520) in the lower left quadrant, percent full or empty status of tanks (as percentage of full or empty) in the upper right quadrant, and an excessive liquid usage notification in the lower right quadrant. The combination of analytics provides much information of interest to the end user in an easy to understand form and provides a basis for the interested person to make any liquid usage adjustments that may be desired. Suggestions or recommendations for consideration by the end user may likewise be provided.

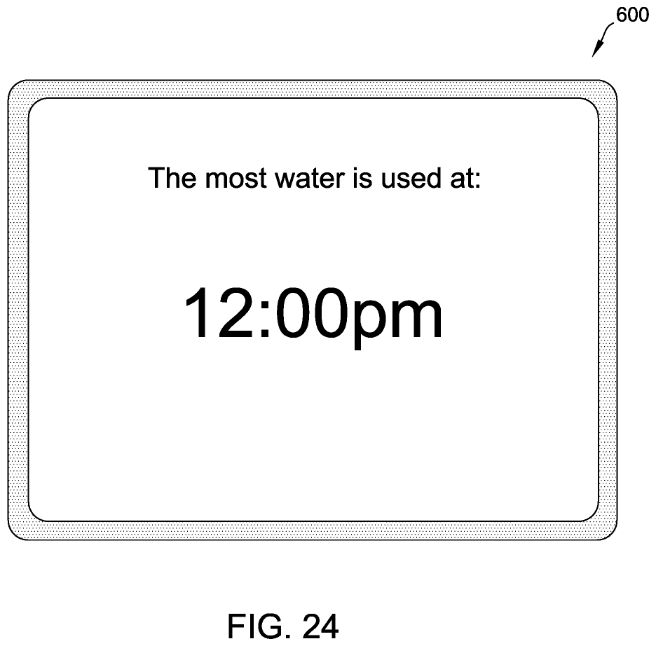

FIG. 24 illustrates a sixth exemplary user interface graphical screen display 600 generated by the processes 450 illustrated in FIG. 18 and implemented in the system 400 shown in FIG. 17. The screen display 600 includes a peak liquid usage analytic for the benefit of the interested person. The peak usage information in the example shown reports peak usage in a one-hour interval, so the most water used at 12:00 pm means that more water is used between 12:00 pm and 1:00 pm than in any other hour of the day. The peak usage analytic is an informative reference point for the interested person to make adjustments, if desired, to reduce water usage at peak times, which would likely have an outsized influence in positively affecting the other analytics to delay problematic empty tank or full tank events that will affect critical use of a vehicle. The system may identify specific liquid devices that account for peak usage for suggestions and recommendations of practical ways to conserve liquid when needed.

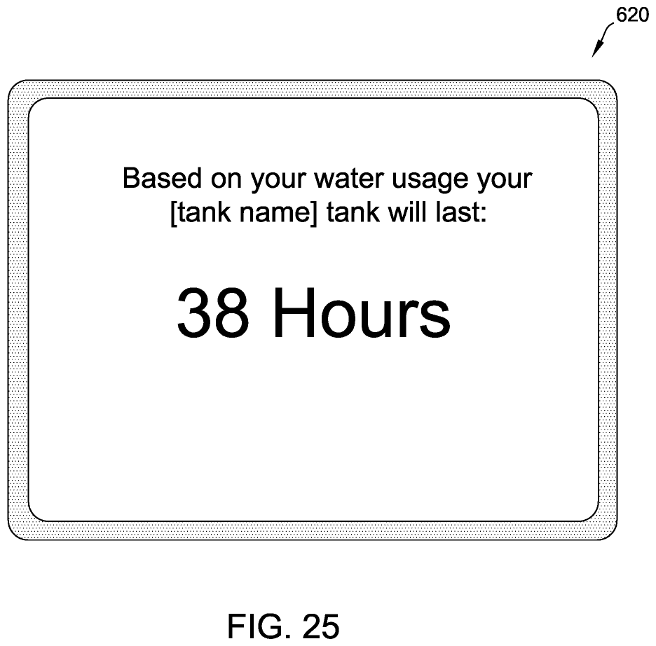

FIG. 25 illustrates a seventh exemplary user interface graphical screen display 620 generated by the processes 450 illustrated in FIG. 18 and implemented in the system 400 shown in FIG. 17. The screen display 620 includes a predictive analytic (time to empty) for a particular tank (e.g., a freshwater tank). Similar screens could be implemented showing each tank being monitored one at a time. For collection tanks (e.g., grey or black water tanks) predictive analytics for time to fill the tanks may be provided. Again, suggestions or recommendations may be provided based on the data collected and analyzed by the system to conserve liquid use.

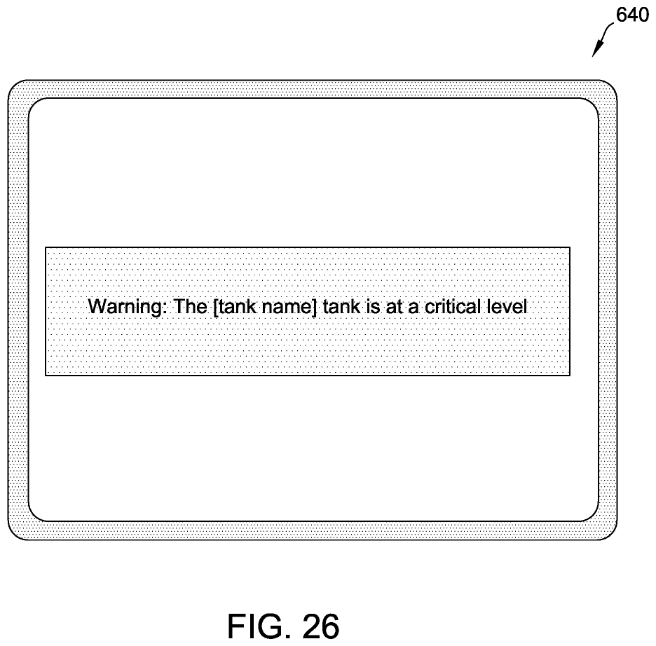

FIG. 26 illustrates an eighth exemplary user interface graphical screen display 640 generated by the processes 450 illustrated in FIG. 18 and implemented in the system 400 shown in FIG. 17. The screen display 640 includes a critical level warning for an identified tank. The warning in the screen display 640 may be generated when the identified tank passes a predetermined limit or threshold corresponding to a critically low amount of liquid left (i.e., a nearly empty tank) or a critically high amount of liquid collected (i.e., a nearly full tank) as applicable to the tank being monitored. The warning screen display 640 may be accentuated with a red background color that differentiates from the screen displays of FIGS. 19-25 that do not include a warning. The differentiated background color of the warning screen display 640 may attract attention of the end user in a way that non-warning screens do not.

The screen display 640 may also be configured as a “blocking warning”. As used herein, a blocking warning means that the normal user interface interaction is precluded until the warning is acknowledged. The acknowledgement by the end user may be made in any manner desired, including but not limited to touching the screen or manipulating another input selector. User acknowledgment provides assurance that the user is informed of critical levels in a specific tank. The critical warning level underlying the warning may be selected or customized by the end user so that warning activation occurs at desired levels. Nuisance-type warnings can therefore be avoided for particular end-users or adjusted for different occasions so that the system is more or less sensitive as needs dictate. Escalating alarm features can be implemented if the user does not acknowledge the warning in a predetermined time period which may be selected or customized by end users to flexibly meet different needs and preferences.

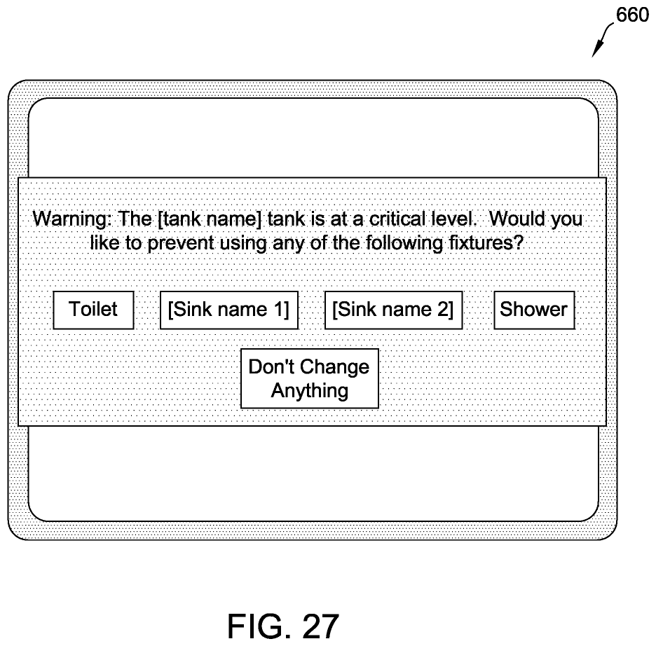

FIG. 27 illustrates a ninth exemplary user interface graphical screen display 660 including a critical level warning analytic with responsive action options generated by the processes illustrated in FIG. 18 and implemented in the system shown in FIG. 17. The screen display 660, unlike the screen display 640, includes a set of responsive actions offering the interested user a choice to shut off liquid use devices such as the buttons shown in the screen display 600 for a respective toilet, a first sink, a second sink, or a shower. If the user selects any of them via the respective buttons provided, the system automatically deactivates the chosen liquid device such that it can no longer use liquid in response to the tank being identified at the critical level. Such deactivation may include an automatic operation of a shut off valve or another device provided in and connected to the system.

For example, the centralized processor device 406 (FIG. 17) may be operatively connected to liquid devices via control connections to any associated valves, pumps or power associated with each liquid device. The centralized processor device 406, via the connections established, may issue a control command which causes an automatic shut off or disables the devices and therefore precludes them from further emptying or filling the tank 100 when needed. As shown in the display screen 660, more than one of the liquid use devices may be selected by the user and automatically shut off by the system in response. Such automatic shut off will limit or slow the rate of any further undesirable depletion of liquid or collection of liquid in the storage tank 100. The system may therefore proactively assist in delaying, if not avoiding, a negative impact to critical functionality of the device or system served by the storage tank 100 until the storage tank 100 can be filled or emptied.

Optionally, an option is also presented in the screen display 660 to the end user via another button which when selected acknowledges the warning but does not change anything (i.e., none of the liquid devices are shut off). Of course, options to select the liquid use devices or to opt not to change anything may be made via features other than buttons as shown. Escalating alarm features can be implemented if the user does not make one of the selections of the options presented or acknowledge the warning in a predetermined time period which may be selected or customized by end users to flexibly meet different needs and preferences.

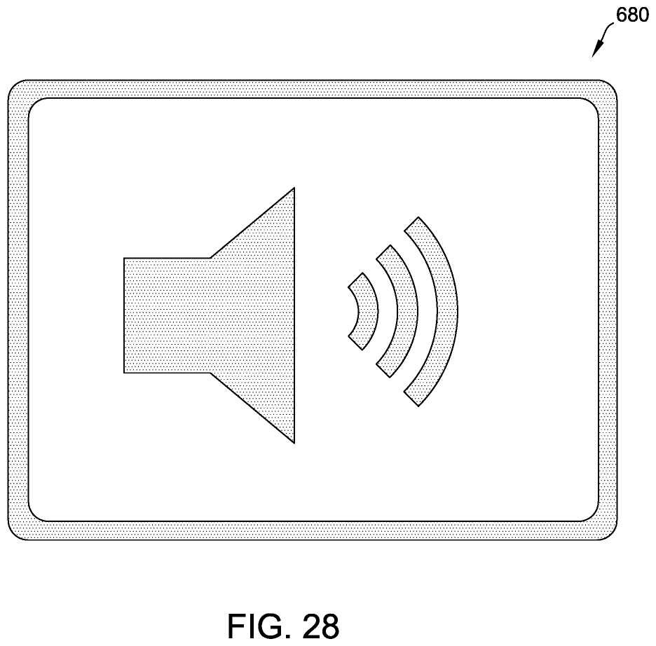

FIG. 28 illustrates a tenth exemplary user interface graphical screen display 680 generated by the processes illustrated in FIG. 18 and implemented in the system shown in FIG. 17. The screen display 680 includes an audio alert symbol such as the speaker symbol shown.

In one contemplated example, an audio alert is a type of warning that is provided when a water use event meets certain criteria. For the purposes herein, a water use event is defined as a single, observable liquid level change. The criteria for the audio alert may be selected or customized by the end user, and specifically such criteria may include a duration of water use or the quantity of water used. If either the selected duration or the quantity criteria is exceeded, the audio alert is triggered by the system. This audio alert may be communicated via a combination of the visual screen display 680 and auditory feedback, or only as auditory feedback. Chimes or particular sounds may be associated with audio alerts and may be selectable by the end user according to user preference. The screen display 680 may be configured as a blocking warning as described above.

The screen display 680 in certain embodiments may be accompanied by audio notification such as a spoken voice message conveying water use or other event detection and analytic information to the end user. The screen display 680 may optionally include a play button to play the voice message. Interactive voice response features may be implemented in further and/or alternative embodiments for user acknowledgement of the audio alert or for the user to select an action to be taken in response, such as the aforementioned options to shut off one or more devices. Audio notifications may include suggestions and recommendations made by the system to conserve liquid. In some cases, video messages may be employed as a form of feedback from the system.

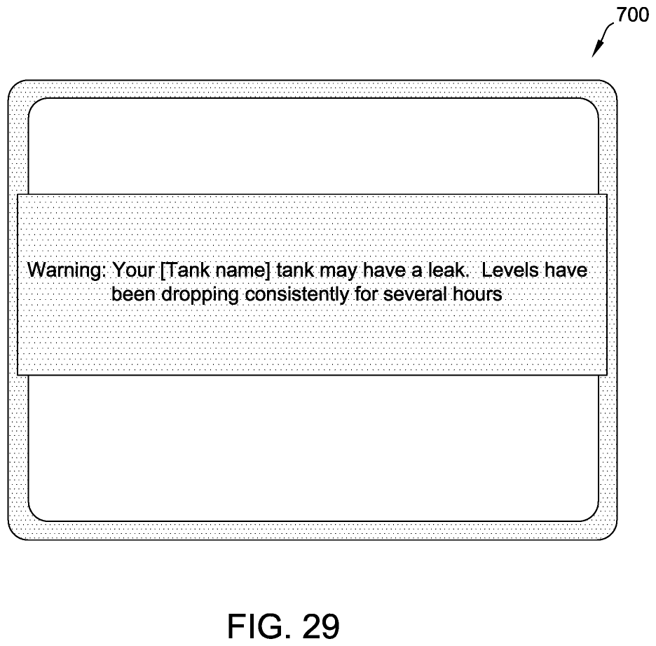

FIG. 29 illustrates an eleventh exemplary user interface graphical screen display 700 generated by the processes illustrated in FIG. 18 and implemented in the system shown in FIG. 17. The screen display 700 includes a leak detection warning for an identified tank. Suggestions or recommendations may be made by the system to confirm the leak or service the tank as needed. The screen display 700 may be accompanied by auditory feedback, and the screen display 700 may be configured as a blocking message. Similar screen displays could be generated for anomalous events other than leaks which are detectable with the system.

Having described the applicable operating algorithms functionally per the description above for the processes 450 and the screen displays of FIGS. 19-29 implemented in the system 400, those in the art may accordingly implement suitable algorithms via programming of the processor-based computing devices. Such programming or implementation of the concepts described is believed to be within the purview of those in the art and will not be described further.

FIG. 30 is a block diagram of a portion of a liquid usage analytical monitoring and management system 750 executing the exemplary processes 450 of FIG. 17 including the screen displays shown in FIGS. 19-29.

The system 750 includes an analytic device 752 which is shown to include a central processor unit (CPU) including one or more processors or microprocessors 754, a memory 756, a communication element 758 and an optional web interface 760. The analytic device 752 is in communication with a display device 800. The analytic device 752 may correspond to the centralized processor device 406 in the system 400 shown in FIG. 17 or another sensor as desired.

The display device 800 includes a CPU including one or more processors or microprocessors 802, a memory 804, and a communication element 806. The communication element 806 is a known element communicating with the web interface 760 of the analytic device 752 in a known manner using a wired or wireless communication path to establish an Internet connection between the devices using known communication protocols and techniques. The communication element 806 may likewise establish a direct connection with the communication element 758 of the analytic device 752 via a wired or wireless path.

When the display device 800 is configured as a mobile computing device (e.g., a smartphone or tablet computer device) or as smart display monitor device as non-limiting examples, the display device 800 may include a user interface application running on the one or more processors or microprocessors 802 that establishes communication with the analytic device 752. The user interface application may accept settings and user-defined inputs through interactive features for operation of the analytic device 752 and send appropriate parameters to the analytic device 752 to control how the analytic device 752 processes data and the desired format it uses to present information. The desired format may include the graphical screen displays of FIGS. 19-29. Navigational home pages and sub-pages each including organized buttons, menus and sub-menus, drop-down selection fields, fill-in data entry fields, pop-up dialog boxes, check boxes and other known features familiar to app developers and users may be implemented in the user interface application. The user interface application may be designed to run in, for example, an iOS operating system, an Android operating system, or other operating system for the analytic device 752 while still communicating seamlessly with the analytic device 752 running on still another known operating system.

The display device 800 may as shown also include a display 810 that is configured to be a touch sensitive display or tactile display that is fully operative as a known input/output device, a microphone 812, a speaker 814, and a tactile device 816 such as a vibration element. The display 810, speaker 814 and tactile device 816 may be provided as built-in elements of the display device 800 when configured as mobile device such as a tablet computer, a smartphone or a notebook or laptop computer. The display 810, speaker 814 and tactile device 816 may alternatively be provided at least in part as separate components usable together in a desktop, workstation or computer terminal set up. Optionally, additional input/output components such as a mouse, stylus and keyboard may be provided when desired.

The speaker 814 may be a built-in speaker for the device 800, a separately provided speaker, an audio jack providing an audio signal output from the device, and any connected headphone or headset arrangement and wireless ear bud components that a user may enjoy when using the device 806. External microphones may also be employed in connection with the device 800 via wired arrangements in known types of headphones, wired and wireless headsets, or wired and wireless handheld microphones that may be hand-held, tabletop devices, or secured in desired locations relative to computer monitors and the like in a home or office environment.

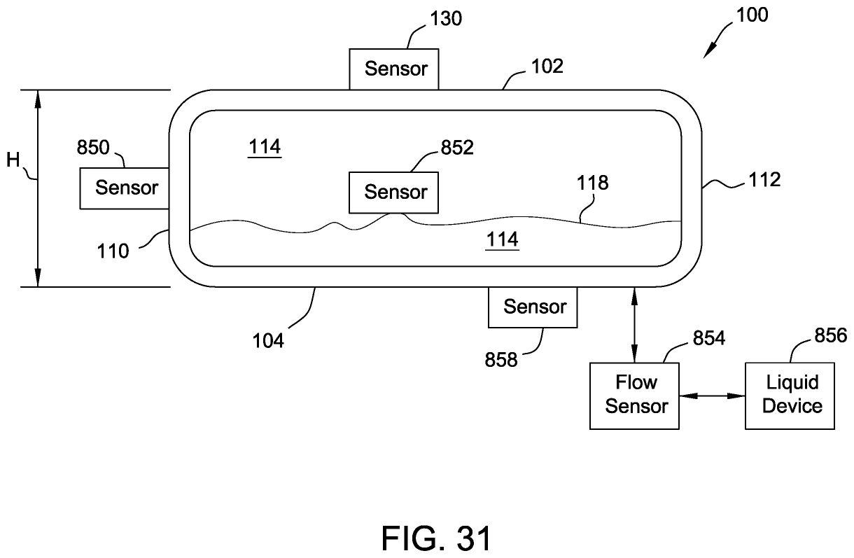

FIG. 31 illustrates another cross-sectional view of the mobile, liquid storage tank shown in FIG. 2 with further exemplary liquid level sensors, liquid usage sensors, and controls.

As shown in FIG. 31, the low-profile storage tank 100 is shown with various types of liquid level detection sensors each detecting a liquid level inside the storage tank using different technologies and different methods. Specifically, the sensors include the radar sensor 130 (also shown in FIG. 2 and specifically described in the exemplary embodiments of FIGS. 2-9), a capacitive sensor element 850, a float sensor element 852, an in-line flow sensor 854, and an ultrasonic or sonar sensor 858. Such sensor elements 130, 850, 852, 854, or 858 are independently operable from one another to detect the liquid level inside the tank 100 in a respectively different manner using different techniques (e.g., measured change in capacitance, measured displacement, measured flow rate, radio detection and ranging).

Additionally, sensors 130, 850, 852, 854, and 858 measure the liquid level inside the tank 100 from different respective locations or positions and therefore from different points of reference. The capacitive sensor 850 is mounted to an exterior of one of the tank side walls 110 or 112. The float sensor 852 is inside the tank interior cavity 114 and is operative with respect to a surface 118 of the liquid 116 in the tank 100. The radar sensor 130 is mounted to the top wall 102 of the tank 100. The in-line flow sensor 854 is associated with one or more devices 856 which either utilizes dispensed liquid from the tank 100 or collects liquid for storage in the tank 100, either of which can be utilized to calculate liquid level inside the tank 100 over time. As non-limiting examples, devices 856 that utilize dispensed liquid from the storage tank 100 may include a tap, a faucet, a showerhead, a hose, an appliance (e.g., a dishwasher, a laundry machine, an icemaker, a coffee maker) or an engine. Non-limiting examples of devices 856 that collect liquid for the storage tank 100 include a sink, a vessel, a drain, a toilet or an appliance (e.g., a dishwasher or laundry machine). The ultrasonic or sonar sensor is either external to the tank on the bottom or internal to the tank on the bottom.

In contemplated embodiments, any one of the sensor elements 130, 850, 852, 854, 858 may be considered sufficient for purposes of monitoring the tank 100 and providing the type of beneficial analytics and screen displays described above, although combinations of the sensor elements 130, 850, 852, 854, 858 (i.e., more than one type of sensor element) may be advantageously utilized in combination to provide further sophistication of the monitoring system to generate a single output that is robust from sensor measurement variation and error that may occur. Combinations of sensor elements in the system may in some cases realize a desirable degree of system redundancy, and in such cases data outputs from the sensor combinations provided may be compared to one another to provide further assurance of accurate readings as well as diagnosis of inoperative sensors and error conditions when data liquid level detection by the respective combinations are inconsistent with one another. As such, liquid level measurement outputs from the combinations of sensors 130, 850, 852, 854, 858 may be considered in combination to determine a single liquid level output that is robust to measurement variation by one or more of the sensors 130, 850, 852, 854, 858. Aspects of the algorithms described above may be applied to determine the single liquid level output measurement by comparing the sensor outputs to one another, to predetermined thresholds, and/or to previous measurements or determinations to produce the single liquid level output. Each of the sensor elements 130, 850, 852, 854, 858, whether implemented as stand-alone sensors or as combinations of sensors operative with respect to the storage tank 100, advantageously addresses issues posed by conventional probe sensors that lack precision, reliability and resolution to provide a desirable degree of liquid monitoring and management functionality as discussed above.

In a contemplated example, the sensor element 850 may be a known capacitive sensor assembly that may be attached to the exterior side wall 110 (or alternatively to the side wall 112) of the storage tank 100. Such capacitor sensor assemblies may include, for example, SeeLeveL™ tank monitor components available from Garnet Instruments, Ltd. See https://www.garnetinstruments.com/holding-tanks/. Capacitive sensor assemblies of the contemplated type may include two vertical strips of metal with small horizontal spacing between them. A measured capacitance between the strips varies depending on the liquid level inside the tank 100. The structure and operation of such sensor assemblies is well known and is not described further herein for the sake of brevity.

In different contemplated embodiments, the capacitive sensor assembly for the sensor element 850 may be implemented as a single large vertical strip with additional smaller strips arranged as an array in a predetermined vertical spacing from one another on the tank side wall. The array of smaller strips is positioned to the side (horizontally) of the larger vertical strip. Each smaller strip in the array detects the water level through the tank side wall at the corresponding elevation of each strip on the side wall. Finer increments of liquid level detection are possible relative to the aforementioned probe sensors to reduce problematic ambiguity of how much liquid is actually in the tank at any given point in time.

Because the sensor element 850 is not inside the tank 100, the capacitive elements included in the sensor element 850 are not as prone to reliability issues because of conditions inside the tank, and such sensors may therefore be reliably used with grey or black storage tanks, for example, which may include solids and sediments therein. Also, additional capacitive strips can easily be provided on the tank side wall to realize a finer gradation in measured liquid levels such as in 3-5% increments instead of 33% increments via known sensor probe systems. The capacitive strips may be operable with, for example, a resolution of about 6.35 mm in a contemplated example. Problematic ambiguity in actual water level via finer gradation of detected liquid level is therefore practically eliminated, albeit with some expense and complication due to the greater number of sensors needed to operate this type of system to achieve fine gradations of sensed liquid level in the storage tank 100.

For instance, to sense the full range of zero to 100% liquid level in the tank 100 in 5% increments, 20 capacitive sensors would be needed on the tank side wall. A relatively complex communication and control setup would also be needed to independently operate the 20 sensors, process the sensor outputs and provide the desired water level output over time for the benefit of the end user or an automated control system. Such expense and complication in the communication and control setup would further be incurred on a per-tank basis, so a monitoring of three liquid storage tanks with sensors arranged to measure liquid level in 5% increments each would require 60 sensors (20 for each of the three tanks) that would individually need to communicate with a centralized processing unit. System installation and setup, as well as diagnosing and troubleshooting a system having such a large number of sensors to achieve and maintain its full operation can in some cases be challenging, although with proper installation and setup the capacitive sensors may successfully generate the data outputs needed to produce the type of liquid usage analytics, water management recommendations, proactive warnings or alerts, and associated screen displays and informational reports such as those described above.

If any of the large number or capacitive sensors involved ceases to operate properly, gaps in the desired granularity of measurements will result. For example, assuming a set of sensors arranged to sense liquid level from zero to 100% full in 5% increments, if the sensor at the 15% full position fails, the remaining set of sensors can sense liquid level in a range from zero to 10% and 20% to 100%. This may not be easily detected or corrected if it happens, but it can introduce problems from an analytical perspective and for providing informational reports to interested persons. Particularly, and for example, when the system is set to trigger an alert, notification or warning when the tank is 15% full, such alerts or notifications will not be generated because the threshold level of 15% cannot be sensed by the system in this state. Additionally, the lack of 15% readings in the data sets produced by the sensors may introduce computational errors in calculating liquid usage rates and/or in predicting usage rates and tank full or tank empty events based on historical data. Similar issues may occur with sensor sets arranged to sense liquid level from zero to 100% empty.

The use of another type of sensor 130, 852, 854, 858 in combination with the sensor 850 may effectively address the issues above by providing another independent liquid level reading which may produce, for example, a 15% reading and cause the system to trigger an alert or notification when the sensor 850 does not, or to produce a more accurate liquid usage rate or prediction than otherwise would be possible using the sensor 850 alone which cannot detect the 15% level. By providing another sensor output from (e.g., from the float sensor 852) to compare to the output from sensor 850, errors in the sensor 850 may be detected and flagged for resolution while still providing accurate liquid level storage and liquid usage rate data. Beneficially, the sensor 850 may detect another liquid level that the float sensor 852 may not be able to in some circumstances.

Analysis of historical data from the sensor 850 may also allow errors to be deduced and flagged for resolution even when the sensor 850 is used alone. Following the example above, if it is seen in the data that liquid levels above and below 15% are being measured without an intermediate 15% reading, the system may deduce that the sensor lacks capability to make the 15% reading. A warning or notice can be generated to communicate the issue with the operation of the sensor 850, but the system may otherwise interpolate or correct its readings to provide a reliable estimate or prediction despite the absent 15% level data if sufficient data was available at the 10% and 20% levels. For example, if the average time between detected 10% and detected 20% levels was found to be relatively consistent over a large enough data set, the system could deduce that the 15% level is likely to be reached in ½ of the average time between the 10% and 20% levels and the system could therefore generate an analytic, alert or notification for the 15% level even though the sensor 850 did not actually detect it. As such, the system may intelligently compensate for errors in the sensor readings when the sensor is only partially compromised so long as the extent of such compromise is known. In the example above wherein there are 20 capacitive sensors measuring liquid level in 5% increments, the failure of the single sensor at the 15% increment would still mean that the other 19 sensors are operating. At some level, though, as the number of sensor increments which are compromised grows, compensation at the algorithmic data processing level becomes increasingly challenging, and perhaps unfruitful. In such cases, the system can generate alerts or warnings that analytics and recommendations, or the featured warnings or alerts, should not be relied upon due to critical sensor error or malfunction. Optionally, the system may cease to provide analytics, recommendations, warnings or alerts altogether until sufficient liquid level sensing capability is restored.

The float sensor element 852 may be a known type of float sensor that has been used in small mobile tanks such as vehicle fuel tanks, but as far as the inventors are aware float sensors have not been utilized in low-profile, mobile water storage tanks such as the tank 100 or been used to generate the type of liquid usage analytics and proactive management afforded by the data analytics and screen displays. Because the float sensor 852 is inside the tank 100, it may become unreliable in black and gray water applications for example due to solids or sediment inside the tank, but the float sensor 852 may operate satisfactorily in a freshwater tank or other tank where solids and sediment in the tank are not of concern. Relative to known probe sensors, granular and relatively non-gradated liquid level detection sensing in the tank 100 is possible with the float sensor 852 when properly calibrated, so generated data outputs needed to produce the type of water usage analytics and proactive management of liquid usage as described above.

As the low-profile height dimension of the tank 100 decreases, the float sensor 852 may become increasingly difficult to calibrate to accurately determine the liquid level in the tank 100 in a precise manner, but the float sensor 852 may be satisfactory in other ranges of the low-profile height dimension (or alternatively in a non-low-profile storage tank) wherein the liquid level and the float sensor 852 may fluctuate a sufficient distance between full and empty conditions that the sensor 852 can be calibrated to accurately measure the liquid level in the full range from zero to 100% full or zero to 100% empty.

The in-line flow sensor element 854 may be a known type of flow sensor such as, for example, the commercially available Moen Flo Smart Water Monitor and Shut Off (https://shop.moen.com/pages/flo-smart-water-monitor) that to date has been used in residential plumbing systems, but to the knowledge of the inventors has not been utilized to sense or monitor liquid level in storage tanks, let alone a low-profile, mobile storage tank such as the tank 100. Such an in-line flow sensor 854 may or may not be compatible with grey and black water storage tanks due to solids and sediment that could affect their operation but could be reliably used with freshwater tanks. Generated data outputs by the in-line flow sensor element 854 may beneficially allow the type of water usage analytics and informational reports described above in a straightforward manner, and in some cases the in-line flow sensor element may be used in combination with the sensor 130, 850, 852 or 858 to provide a desired degree of redundancy and assurance that analytics may not be compromised by the limitations of the in-line flow sensor 854 in some operating conditions.

The ultrasonic or sonar sensor element 858 may be a known type of sensor such as, for example, the commercially available Mopeka Pro Check Universal sensor (https://mopeka.com/product/mopeka-pro-check-universal-aluminum-plastic-composite-and-poly-tanks) which is typically used for metal pressurized liquid propane (LP) tanks but could also potentially be used in water tanks. The ultrasonic sensor element 858 may be used in combination with the sensor 130, 850, 852, or 854 to provide a desired degree of redundancy and assurance that analytics may not be compromised by the limitations of the ultrasonic sensor 858 in some operating conditions.

In addition to capacitive sensors, float sensors, radar sensors, in-line flow sensors, and ultrasonic or sonar sensors that are discussed above, other sensors technologies may exist or may be discovered that can be used in combination with the sensor technologies mentioned above may to achieve the desired degree of redundancy and assurance that analytics may not be compromised by the limitations of a single sensor technology. Additionally, multiple devices of the same sensor technology, even sensor technologies not mentioned above, may be utilized to achieve the desired degree of redundancy and assurance that analytics may not be compromised by the limitations of a single mounting location. For example, water pressure sensors or weight sensors, while they have not been discussed above, may be used in a similar way to the sensor technologies mentioned above to achieve the same benefits.

The sensor systems, processes, analytic devices and display devices described are implemented with processor-based devices that each include a controller such as a microprocessor and a memory storage wherein executable instructions, commands, and control algorithms are stored, as well as other data and information required to satisfactorily operate the pertinent devices in the systems and to perform aspects of the methods described herein. The memory of the processor-based devices may be, for example, a random access memory (RAM), and other forms of memory used in conjunction with RAM memory, including but not limited to flash memory (FLASH), programmable read only memory (PROM), and electronically erasable programmable read only memory (EEPROM) may likewise be included.

One or more computer-readable storage media may include computer-executable instructions embodied thereon for interfacing with the pertinent processor-based devices described. When executed by the processor in each respective device the computer-executable instructions may cause the processor to perform one or more algorithmic steps of a method such as the methodology of the systems described above via one or more of the processors included. As such, the processor in the radar sensors may operate the radar transmitters and receivers and obtain the multiple radar returns to measure the liquid level in the storage tank. Likewise, the processor in the device 150 described above may perform the assessment of the radar returns for each tank being monitored to provide the single output 160 with improved accuracy. The centralized processor 406 may collect outputs from the sensor for display and communication in a vehicle 402, and an analytic device 752 and display 800 may be provided for communication of analytics as desired.

While various different processors have been described it is recognized that the functionality by the different processors may be combined in the systems and methods described. For example, the processor-based device which produces the single, combined output for each monitored tank may process the single, combined output to generate aspects of the liquid usage analytics, recommendations or warnings described herein which may be reported to another processor-based device that generates the graphical screen displays or audio and tactile alerts as described above. When executed by the processor in each respective device the computer-executable instructions may cause the processor to perform one or more algorithmic steps of the processes described herein, including but not necessarily limited to the processes 300 (FIG. 16) and the processes 450 (FIG. 18) which may be embodied in the exemplary screen displays shown in FIGS. 19-29.

The above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the embodiments described above. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Such computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

The applications described above are flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described. Each component and process can also be used in combination with other assembly packages and processes.

The benefits of the inventive concepts are now believed to have been amply illustrated in relation to the exemplary embodiments disclosed.

A monitoring system for at least one mobile liquid storage tank has been disclosed. The system includes a plurality of independently operable sensor elements each configured to measure a liquid level inside the at least one mobile liquid storage tank and at least one processor that is configured to: iteratively receive a liquid level measurement from each respective one of the plurality of independently operable sensor elements; determine, based on the iteratively received liquid level measurements, a single liquid level output measurement that is robust to measurement variation by one or more of the plurality of independently operable sensor elements; and based on the determined single liquid level measurement over time, determine at least one liquid level usage analytic for liquid dispensed from the at least one mobile liquid storage tank or liquid collected in the at least one mobile liquid storage tank; and at least one display visually presenting the at least one liquid level usage analytic.

Optionally, the plurality of independently operable sensor elements may include radar transmitter and receiver combinations operable to provide a plurality of radar returns from respectively different locations relative to the at least one mobile liquid storage tank. The at least one mobile liquid storage tank may include opposed top and bottom walls and opposed first and second side walls interconnecting the top and bottom walls, and wherein the radar transmitter and receiver combinations are arranged on an exterior of the top wall. The at least one mobile liquid storage tank may be configured as a low-capacity storage tank. The at least one mobile liquid storage tank may further be configured as a low-profile storage tank. The at least one mobile liquid storage tank may be a vehicle system storage tank.

The vehicle system storage tank may be a water tank supplying liquid to one or more liquid use devices or collecting liquid from one or more liquid use devices. The liquid use devices may be selected from the group of a tap, a faucet, a showerhead, a hose, an appliance, a sink, a vessel, a drain, and a toilet. The water tank may be a freshwater tank supplying water to the one or more liquid use devices. The water tank may be a grey water tank or a black water tank.

As further options, the plurality of independently operable sensor elements may be selected from the group of capacitive sensor elements, float sensors, in-line flow sensors, and radar sensor elements. The at least one mobile liquid storage tank may include opposed top and bottom walls and opposed first and second side walls interconnecting the top and bottom walls, and the plurality of independently operable sensor elements may include capacitive sensor elements arranged on an exterior of one of the first and second side walls. The at least one processor may be configured to compare liquid level measurement data from the plurality of independently operable sensor elements and provide a single liquid level output.

The at least one processor may also be configured to generate a set of informational liquid level usage analytic screen displays for visual presentation to an interested party. The set of informational liquid level usage analytic screen displays may include a critical liquid level warning for the at least one mobile storage tank. The system may also include at least one liquid use device dispensing stored liquid from the at least one mobile liquid storage tank or collecting liquid to be stored in the at least one mobile liquid storage tank, and the at least one processor may also be configured to issue at least one control command to disable the liquid use device from further dispensing stored liquid or collecting liquid in response to the generated critical liquid level warning. The set of informational liquid level usage analytic screen displays may include an option to the interested party to disable the at least one liquid use device, and when the interested party accepts the option the system automatically issues the control command.

The critical liquid level warning may be configured as a blocking warning. The set of informational liquid level usage analytic screen displays may include an excessive liquid usage event for stored liquid in the at least one mobile liquid storage tank. The system may be configured to generate at least one of a notification, an alert or a warning related to the excessive liquid usage event. The set of informational liquid level usage analytic screen displays may include a liquid leak event, and wherein the system is configured to generate at least one of a notification, an alert or a warning related to the liquid leak event. The set of informational liquid level usage analytic screen displays may include a predicted tank full event or a predicted tank empty event. The system may be configured to suggest or recommend a liquid management action. The system may be configured to identify and distinguish a plurality of liquid use devices with respect to an identified liquid usage event.

The system may also be configured to generate an audio communication relating to a liquid usage concern. The set of informational liquid level usage analytic screen displays may include at least one simultaneous presentation of a plurality of elapsed liquid usage events over a predetermined time period, at least one peak liquid usage event in a predetermined time interval, an average liquid use duration for the at least one mobile storage tank, or a liquid usage management notification or alert with respect to a status of each of the monitored mobile liquid storage tanks.

The at least one processor may be a centralized processor receiving multiple sets of liquid usage data for each of the monitored storage tanks. The at least one display may be a touch screen. The at least one display may include multiple displays. The system may be configured to communicate the at least one liquid level usage analytic to at least one external user device. The at least one external user device may be selected from the group of a smartphone, a tablet computer device, a laptop computer device, and a notebook computer device.

The at least one mobile liquid storage tank may optionally be integrated in a recreational vehicle, a food truck, a recreational boat, or a semi-truck equipped with living quarters. The at least one mobile liquid storage tank may be a water tank. The water tank may be a grey water tank or a black water tank. The at least one mobile liquid storage tank may include multiple mobile liquid storage tanks dispensing water or collecting water associated with liquid use devices in the vehicle. The system may also include a tactile feedback element, the tactile feedback element automatically activated in response to a detected liquid usage concern.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system for at least one mobile liquid storage tank, the system comprising:
a plurality of independently operable sensor elements each configured to measure a liquid level inside the at least one mobile liquid storage tank; and
at least one processor that is configured to:
iteratively receive a liquid level measurement from each respective one of the plurality of independently operable sensor elements;
determine, based on the iteratively received liquid level measurements, a single liquid level output measurement that is robust to measurement variation by one or more of the plurality of independently operable sensor elements; and
based on the determined single liquid level measurement over time, determine at least one liquid level usage analytic for liquid dispensed from the at least one mobile liquid storage tank or liquid collected in the at least one mobile liquid storage tank; and
at least one display visually presenting the at least one liquid level usage analytic.

2. The system of claim 1, wherein the plurality of independently operable sensor elements includes radar transmitter and receiver combinations operable to provide a plurality of radar returns from respectively different locations relative to the at least one mobile liquid storage tank.

3. The system of claim 2, wherein the at least one mobile liquid storage tank includes opposed top and bottom walls and opposed first and second side walls interconnecting the top and bottom walls, and wherein the radar transmitter and receiver combinations are arranged on an exterior of the top wall.

4. The system of claim 3, wherein the at least one mobile liquid storage tank is configured as a low-capacity storage tank.

5. The system of claim 4, wherein the at least one mobile liquid storage tank is further configured as a low-profile storage tank.

6. The system of claim 3, wherein the at least one mobile liquid storage tank is a vehicle system storage tank.

7. The system of claim 6, wherein the vehicle system storage tank is a water tank supplying liquid to one or more liquid use devices or collecting liquid from one or more liquid use devices.

8. The system of claim 7, wherein the liquid use devices are selected from the group of a tap, a faucet, a showerhead, a hose, an appliance, a sink, a vessel, a drain, and a toilet.

9. The system of claim 7, wherein the water tank is a freshwater tank supplying water to the one or more liquid use devices.

10. The system of claim 7, wherein the water tank is a grey water tank or a black water tank.

11. The system of claim 1, wherein the plurality of independently operable sensor elements is selected from the group of capacitive sensor elements, float sensors, in-line flow sensors, and radar sensor elements.

12. The system of claim 11, wherein the at least one mobile liquid storage tank includes opposed top and bottom walls and opposed first and second side walls interconnecting the top and bottom walls, and wherein the plurality of independently operable sensor elements comprises capacitive sensor elements arranged on an exterior of one of the first and second side walls.

13. The system of claim 11, wherein the at least one processor is configured to compare liquid level measurement data from the plurality of independently operable sensor elements and provide a single liquid level output.

14. The system of claim 1, wherein the at least one processor is further configured to generate a set of informational liquid level usage analytic screen displays for visual presentation to an interested party.

15. The system of claim 14, wherein the set of informational liquid level usage analytic screen displays includes a critical liquid level warning for the at least one mobile storage tank.

16. The system of claim 15, further comprising at least one liquid use device dispensing stored liquid from the at least one mobile liquid storage tank or collecting liquid to be stored in the at least one mobile liquid storage tank, and wherein the at least one processor further is configured to issue at least one control command to disable the liquid use device from further dispensing stored liquid or collecting liquid in response to the generated critical liquid level warning.

17. The system of claim 16, wherein the set of informational liquid level usage analytic screen displays includes an option to the interested party to disable the at least one liquid use device, and when the interested party accepts the option the system automatically issues the control command.

18. The system of claim 15, wherein the critical liquid level warning is configured as a blocking warning.

19. The system of claim 14, wherein the set of informational liquid level usage analytic screen displays includes an excessive liquid usage event for stored liquid in the at least one mobile liquid storage tank.

20. The system of claim 19, wherein the system is configured to generate at least one of a notification, an alert or a warning related to the excessive liquid usage event.

21. The system of claim 14, wherein the set of informational liquid level usage analytic screen displays includes a liquid leak event, and wherein the system is configured to generate at least one of a notification, an alert or a warning related to the liquid leak event.

22. The system of claim 14, wherein the set of informational liquid level usage analytic screen displays includes a predicted tank full event or a predicted tank empty event.

23. The system of claim 14, wherein the system is further configured to suggest or recommend a liquid management action.

24. The system of claim 14, wherein the system is configured to identify and distinguish a plurality of liquid use devices with respect to an identified liquid usage event.

25. The system of claim 14, wherein the system is further configured to generate an audio communication relating to a liquid usage concern.

26. The system of claim 14, wherein the set of informational liquid level usage analytic screen displays includes at least one simultaneous presentation of a plurality of elapsed liquid usage events over a predetermined time period.

27. The system of claim 14, wherein the set of informational liquid level usage analytic screen displays identifies at least one peak liquid usage event in a predetermined time interval.

28. The system of claim 14, wherein the set of informational liquid level usage analytic screen displays includes an average liquid use duration for the at least one mobile storage tank.

29. The system of claim 14, wherein the system is configured to simultaneously monitor multiple mobile liquid storage tanks, and wherein the set of informational liquid level usage analytic screen displays includes a liquid usage management notification or alert with respect to a status of each of the monitored mobile liquid storage tanks.

30. The system of claim 29, wherein the at least one processor is a centralized processor receiving multiple sets of liquid usage data for each of the monitored storage tanks.

31. The system of claim 1, wherein the at least one display is a touch screen.

32. The system of claim 1, wherein at least one display includes multiple displays.

33. The system of claim 1, wherein the system is further configured to communicate the at least one liquid level usage analytic to at least one external user device.

34. The system of claim 33, wherein the at least one external user device is selected from the group of a smartphone, a tablet computer device, a laptop computer device, and a notebook computer device.

35. The system of claim 1, wherein the at least one mobile liquid storage tank is integrated in a recreational vehicle, a food truck, a recreational boat, or a semi-truck equipped with living quarters.

36. The system of claim 35, wherein the at least one mobile liquid storage tank is a water tank.

37. The system of claim 36, wherein the water tank is a grey water tank or a black water tank.

38. The system of claim 35, wherein the at least one mobile liquid storage tank comprises multiple mobile liquid storage tanks dispensing water or collecting water associated with liquid use devices in the vehicle.

39. The system of claim 1, further comprising a tactile feedback element, the tactile feedback element automatically activated in response to a detected liquid usage concern.
